(19) United States
(12) Patent Application Publication
(10) Pub. No.: US 2015/0081395 A1
(43) Pub. Date: Mar. 19, 2015

(54) SYSTEM AND METHOD TO CONTROL DISTRIBUTION OF GOODS IN A VIRTUAL MARKETPLACE

(71) Applicants: Braden Katz, Fairway, KS (US); Kaustubh Dhondge, Kansas City, MO (US)

(72) Inventors: Braden Katz, Fairway, KS (US); Kaustubh Dhondge, Kansas City, MO (US)

(73) Assignee: InfoEffect LLC, Fairway, KS (US)

(21) Appl. No.: 14/281,853

(22) Filed: May 19, 2014

Related U.S. Application Data
(60) Provisional application No. 61/824,506, filed on May 17, 2013.

(51) Int. Cl. G06Q 30/02

(52) U.S. Cl. CPC G06Q 30/0214; G06Q 30/0269; G06Q 30/0206
USPC 705/7.35; 705/14.66; 705/14.16

(57) ABSTRACT

A system providing a marketplace wherein professional goods and creators of the professional goods are organized and ranked to allow a user of the system. The system is configured to allow the creators to control access to their goods made available to consumers via the marketplace. The consumers may use the access to determine a value of goods and directly compensate one or more of the creators for an increased level of access, which may include one or more incentives to gain additional access, for instance, if the consumer shares the good. The system is configured to generate a suggested payment price based on value rating and highest payment data associated with each of the goods, which may be based on feedback from one or more of the consumers. The goods and the creators are organized and ranked by assigning a variable weight to value metrics based on the feedback from the consumers or other action or behavior of the consumer detected by the system.

### CROSS-REFERENCE TO RELATED APPLICATION

This Patent Application claims priority to U.S. Provisional Patent Application Ser. No. 61/824,506 titled Natural Price Ranking Algorithm for a Pay-What-You-Want Content Marketplace, and filed May 17, 2013, the entire contents of which are herein incorporated by reference in its entirety.

### BACKGROUND

1. Field

The present inventive concept generally relates to a system and method for distributing and providing valuation of goods. In an embodiment, the present inventive concept more particularly concerns a system and method that utilize a communication network to offer for sale, arrange purchase and other forms of distribution of, and to rank and provide valuation of goods.

2. Discussion of Related Art

Throughout the history of capitalistic markets, the value of a good and/or service has traditionally been determined by the person or entity that is selling it, in view of larger market forces like supply and demand. This form of human interaction, for example in which a seller determines the money value of good and the buyer must pay this money value in order to obtain rights in the good, has largely been the foundation of capitalistic markets for centuries.

However, the interactions between buyers and sellers in capitalistic markets are fundamentally the result of social human interactions; and these interactions are determined by social standards and assumptions about human behavior and motivation. In most fundamental theories of modern capitalistic markets such as Game Theory, Classical Economics, and Neo-classical economics, it is assumed that human beings act as intelligent rational agents whose main objective is to maximize the personal payoff from an economic interaction. (See Myerson, Roger B. Game Theory: Analysis of Conflict. Cambridge, Mass.: Harvard UP (1991): 2. Print.)

Historically, this assumption about human behavior and motivation was derived from theories of evolutionary natural selection. Namely, “an evolutionary-selection argument suggests that individuals may tend to maximize the expected value of some measure of general survival and reproductive fitness or success.” (Id. at 3) It was these beliefs about human motivation that laid the foundation for most human interactions between buyers and sellers in the global marketplace.

As result, the social standards that have developed from this basic interaction between buyers and sellers in capitalistic markets have eliminated the need for consumers to directly contribute to placing a value on the goods and services that they have purchased beyond merely choosing to purchase or not to purchase, and this social standard has created a natural lack of attention, or detachment, between consumers perceived value of the goods that they buy. This occurs because almost all goods are sold for a fixed, sometimes arbitrary, up front price, in which consumers must decide or guess if a seller's selected value for a specific good is correct. Consumers are then limited to just two choices—they can either pay for the good at Seller's selected money value, or pay nothing and never gain access or ownership of the good.

However, traditional valuation models and buyer/seller interactions have grown inadequate in the digital Information Age, particularly in light of new learning around traditional economic models, and there is a need for a modern system and method for better and more accurate valuation of goods and services.

The transfer of information from one human being to another is fundamental to the advancement of human society, technology and quality of life. The pace of modern advancement in these and other areas would not be possible without the development of publishing technologies capable of recording, storing and distributing information through a medium. The distribution of information on a worldwide scale is dependent at least on (1) the technologies developed to record, store and distribute this information and (2) the social standards developed to foster the exchange of goods. Effective distribution systems, in cooperation with modern legal landscapes, in a market economy support and incentivize the creation of new goods by artists, musicians, film-makers, researchers, journalists, writers, software engineers and other creative entities. “Information goods” include any form of information, regardless of the medium in which it resides, which is or may be offered in exchange for pecuniary remuneration or value, including without limitation books, musical songs, research papers, software programs, films, journalism articles, and the like.

However, the social standards developed by the traditional publishing industry, which arose in part from the general traditional social standards between buyers and sellers in capitalistic markets, combined with the social, economic, and technological changes that have taken place from the mass adoption of personal computing and the Internet, have radically decreased the value of goods in the global marketplace.

This phenomenon began when business models and social standards developed by the traditional publishing industry were disrupted as the costs of recording, storing, and exchanging goods were greatly reduced by the advent and rapid growth of the Internet. The disruption of traditional practices in the publishing industry was exponentially accelerated by the Free Culture Movement and the rise of peer-to-peer file sharing systems. These movements fed creation of a reformed digital and social infrastructure that paved the way for an exponential growth of mass piracy at the turn of the millennium, which in turn led to rise of open distribution and subscription models for goods on the Internet.

However, the wide-scale devaluing of goods cannot be attributed to a single cause, but instead is an economic, social, and technological phenomenon that developed over many centuries based on a variety of factors. From the advent of the printing press to the proliferation of open distribution models on the Internet, those who have controlled the mediums of distributing goods have also contributed significantly to the formation of methods, business models and social standards for exchanging such goods in the global marketplace. For centuries, these social standards, methods, and business models (collectively, the “Traditional Publishing Methods”), developed when mediums of distribution were limited to physical products like physical books, music records, articles, newspapers, and videotapes. As a result, the Traditional Publishing Methods were largely created in accordance with international copyright law and under the assumption that goods could be protected, sold and distributed as physical products in the global marketplace. These assumptions contributed to development of social and economic standards that have historically placed the ability to determine the money value for goods, as wells as the methods for producing, selling, marketing, distributing and profiting from the distribution of goods, in the control of publishers instead of individual creators or others.

Therefore, the valuation control of goods by publishers was perpetuated because historically the mediums for distributing goods were overwhelmingly physical products. As a result, individual creators were almost always incapable of producing, marketing, selling, and distributing these physical products on their own. It was this broad advantage of companies involved in the distribution of physical goods that set the stage for the modern publisher's agreement, which generally places the vast majority of the rights to price, distribute, profit from, and control the exchange of an individual goods in the hands of the publisher, not the good's creator.

Even today, traditional publishers' agreements often claim exclusive, restrictive control of goods in exchange for a money advance and a small percent of the profit (usually 10-15%) attributable to the goods. The goods is generally produced, marketed, and distributed cheaply then generally sold to consumers like any other physical product for a profit—i.e., the distributor determines the money value of the goods, and the consumer pays a fixed, up front, money value in exchange for owning the goods. The contractual control on the distribution of goods by publishers, which was originally established at a time when the only mediums of distributing goods were physical products, explains why so little emphasis has historically been placed on a creator's ability to profit from and control their work according to modern publishers' agreements. It was the social standards and business models developed under the Traditional Publishing Methods that laid the foundation for the control of goods in other widely used methods and business models for distributing professional copyrighted (or paid) goods on the Internet.

The influences of the Traditional Publishing Methods can be most widely seen in the largest online distributers of digital goods today. In most cases, these massive online stores, like iTunes™, Amazon™, and Barnes and Noble™, continue to use the Traditional Publishing Methods because traditional publishers continue to control large portions of professional copyrighted goods through publishers' agreements. As a result, a number of inefficiencies in selling, ranking, and virally distributing professional copyrighted works or goods have emerged in large online “ebook” stores like those mentioned above. In many cases, these inefficiencies occur because digital goods are still treated as a protected, copyrighted physical commodities sold through the general process wherein a consumer must pay a set, up front price, which is chosen by the selling entity in order to gain access to, or ownership of, the goods. This pay-wall system arrests the goods' ability to be virally distributed on the Internet because new consumers cannot instantaneously access the goods(s) without being stopped by a pay wall. Consequently, protected copyrighted digital goods cannot easily be shared on social networks, email, or other internet sharing tools, and as a result, drastically fewer people access protected, copyrighted goods in comparison to goods published more openly on the Internet. As a result, such large online stores often do not collect the same amount of data as other, more open, distribution models, and therefore protected, copyrighted goods in these networks are often ranked by outdated methods such as best-sellers lists and editors' picks.

The internet's ability to spread goods far outstrips the actual distribution of such works, in part because of the dominance of Traditional Publishing Methods. While goods on the open Internet have the ability to be virally distributed and experienced by 30 million people in a single day, it only takes only 3000 digital and physical book sales a week to make it to the top 10 of the Wall Street Journal Best Sellers List. The Free Culture Movement is a symptom of the problems arising from operation under Traditional Publishing Methods in the digital age. The Free Culture Movement began as a response to restrictive copyright laws and perceived publishing monopolies, and its participants hold the belief that “all generally useful information should be free. “By ‘free’ I am not referring to price, but rather to the freedom to copy the information and to adapt it to one's own uses . . . ” (Denning, Dorothy E., “Concerning Hackers Who Break into Computer Systems.” Proceedings of the 13th National Computer Security Conference (1990), http://www.cs.georgetown.edu/˜denning/hackers/Hackers-NCSC.txt: Barlow, John Perry, “The Next Economy of Ideas,” Wired, October 2000 (citing Richard Stallman)) As personal computing and the Internet became exponentially more efficient at recording, storing, and distributing goods, traditional publishing has been consistently disrupted as the sales of copyrighted works in both digital and physical formats significantly decreased. A study conducted by the Pew Research Center relating to the peak usage of Napster™—the first and most famous peer-to-peer file sharing system—estimated that 51% of individuals aged 18-29 and 53% of individuals aged 15-17 had downloaded music illegally over the Internet.

As a result of increased piracy of goods sought to be protected by creators and their publishers by the general public and otherwise, a number of new business models emerged to combat mass piracy and persuade Internet users who had become accustomed to downloading digital goods for free to pay, sometimes nominally, for similar services and thereby mitigate whatever risks such users had taken in downloading content illegally. The most widely used of these models, whose variations can be seen in companies like Netflix™ for film, Oyster™ and Scribd™ for books, and Spotify™ and Rdio™ for Music™, is called the Open Music Model. The Open Music Model, along with its various incarnations (collectively, the “Open Distribution Models”), has become one of the most popular and prolific attempts to emulate the file sharing behavior of users in peer-to-peer systems while staying within boundaries of the law and providing some monetary benefit to creators and publishers. However, these models, which treat the repeated consumption of digital goods as a service rather than individually sold products, rarely generate enough revenue for creators. This occurs because, under these systems, massive quantities of goods are bundled in a network where consumers either pay a small monthly fee—usually the costs of a single album, book or film per month ($5-$10)—or gain access to the network for free with by signing up and being subjected to advertising. Although these models are often successful at virally distributing goods to users, they devalue the goods to the point that it often takes millions of plays, reads, or views for the creators of the goods to make minimum wage.

There are a number of inefficiencies in existing systems and methods relating to ranking, discovering and identifying the highest quality of goods, including works. In addition to the new models for distribution of copyrighted, paid content, there has also been an exponential increase in the number of goods published for free on the open Internet. Consequently, a number of new ways of sorting and ranking free content on the Internet, such as the Google™ PageRank Algorithm and voting systems on popular book marking sites like Reddit™, have been created.

Although these systems are effective in locating and identifying relative free content, their ability to identify the highest quality works is often flawed for a number of reasons. First, common metrics used by sorting and ranking systems for free web content, such as but not limited to, the number of views, back-links social shares, voting content up or down, and “5 star” rating systems, are submitted by individual internet consumers for a number of motivations that often do not reflect the quality of the content. The range of these motivations vary, and there are several reasons why such rating systems may not properly provide valuation of goods such as works, which include without limitation: 1) raters may share an goods that is marginally entertaining but not of real-world value, 2) raters may rate an goods based on the rater's agreement with the views or opinions stated in the content, and 3) raters may rate something with little to no vested interest in the goods. These flawed rating methods are used in connection with free content on the Internet, as well as paid, copyrighted goods distributed in Open Distribution models like Netflix™, Spotify™, and Oyster™. In both cases, identifying the quality and/or real world value of an goods based thereon, especially goods by new or upcoming creators, is often flawed.

There are also a number of inefficiencies and problems with the systems and methods used by large online distributors of goods, including Amazon™, iTunes™ and Barnes & Noble™ as well as all other publishers that use the Traditional Publishing Method, for ranking and discovery of high quality works. These flaws include, most notably, the fact that goods in such marketplaces are treated like protected commodities in which consumers have to pay fixed, upfront prices to own or gain access. Further, such goods published with the Traditional Publishing Method often cannot enable collection of data necessary for the ranking systems that are used for free web-distributed goods and those distributed under Open Distribution Models. As a result, the most popular ranking systems for the Traditional Publishing Method—like best-sellers lists and editors' picks—have been around for centuries, and are often biased towards creators who are popular and in high demand. In some cases, these systems are even being skewed and corrupted by creators who have the ability to purchase thousands of books on their own.

### SUMMARY

The present inventive concept remedies the aforementioned issues with devaluation, ranking, and virally distribution of goods on the Internet by providing a unique social pay-what-you-want virtual marketplace in which goods having sellers and buyers are able to engage in a heightened level of interaction with respect to the goods. In this interaction, the seller of the good determines a degree or level of access among a plurality of different levels that the buyer of the good can gain before being asked to assign a value to the good. For purposes herein, value can mean monetary value, sentimental value, emotional value, educational value, and/or other like value. The levels of access may be, but are not limited to, an amount of time or a payment period that the buyer can view the good in its entirety, an amount of the good the buyer can view, e.g., the buyer may only be able to view a section of the good rather than the entirety of the good, an amount of the good that can be previewed by the buyer. The levels of access define viewing levels effective before the buyer submits a payment for the good and/or shares the good, e.g., within a social network of the buyer. The buyer may assign the monetary value to the good and may choose to pay the seller to gain permanent access to the good. In addition to levels of access, sellers can also determine the value of shares via social networks, email, or other social Internet tools. Buyers can then gain additional access or, if selected by the users, permanent access to the good for sharing the work one or multiple times. Promoting or sharing the goods on the Internet via social sharing tools can then be used as a form of payment or currency for buyers who may not be able pay the seller directly over the Internet for financial or geographical reasons.

The system utilizes two methods that allow buyers to determine the value of the goods after they have gained access to it. In both methods, the buyers must assign a maximum value to a good of the seller in various genres and/or categories. The maximum value is stored in association with each buyer and used to generate a suggested price, and/or a Personal Value Rating in Method 2 for the goods. In Method 1, Supporters Users are asked to select a number on a value scale, such as 1 to 10, after gaining predetermined upfront access to the goods. This value scale selection, which represents a percentage value like 20%, is then multiplied by the highest personal payment of the Supporter user to generate a suggested price for the goods in a specific category. In addition to or alternatively, Method 2 asks Supporters users to determine a payment that represents their personal valuation of the goods, and this payment is then divided by the Highest Personal Payment for the goods' category to determine a percentage value that can be applied to a rating scale such as 1 to 10. It is also important to note that the marketplace may elect to not collect highest payment data, and discern the value of the goods with the Human Impact Ranking System.

A buyer's ability to determine the value of goods would be dependent on the amount of access a seller grants the buyers prior to the buyer making a decision.

When buyers pay for or share goods in the virtual marketplace, they are permanently connected to sellers of those good via the marketplace user interface. This is a buyer connection, which allows buyers to support sellers as the buyers discover the marginal value of the goods, which is anticipated to take a certain amount of time after initial viewing of the good by the buyer.

The system is configured to publish rankings via a ranking module, which is configured to rank goods based on a plurality of weighted factors. The ranking module weighs the plurality of weighted factors with the most weighted factor being amount of payment made by buyers to sellers of the goods. Other less weighted factors include total number of shares and total number of views each of the goods receives. In this manner, the ranking module utilizes human impact ranking and, using predetermined weights assigned to various metrics, ranks goods in the marketplace.

The aforementioned may be achieved by providing a computerized method to distribute goods. The method my include the steps of (i) providing access, via a computer network, to a virtual marketplace having a plurality of goods, each of the plurality goods associated with a first user and a second user, (ii) allowing, via a processor of the network, one of the first users associated with one of the plurality of goods to assign one of a plurality of access levels to each of the second users for the one of the plurality of goods, the plurality of access levels including an initial access level, each of the plurality of access levels controlling a different level of interaction with the second users and the good, (iii)storing, via a memory of the network, the plurality of access levels as associated with each of the second users, (iv) assigning, via the processor, a value to each of the plurality goods, each of the values based on interaction of the second users with each of the goods, (v) organizing, via the processor, the goods based on the values to provide a ranking, and (vi) presenting, via the processor, the goods to the second users based on the ranking.

Each of the plurality of access levels may control a viewing time that each of the second users are able to view a respective one of the goods associated with the access level. The viewing time may be extended a predetermined amount of time each time the second user shares the respective one of the goods with at least one other user. The viewing time may be infinite if the second user shares the respective one of the goods with a predetermined number of other users. The viewing time may be determined based on (i) a number of shares performed by the buyer, and/or (ii) a number of shares required to gain permanent access to the good determined by the seller. The sharing of the good by the second user may include (i) sending a portion of the good selected by the second user to at least one other user, and/or (ii) applying a parameter predetermined by the buyer to the portion of the good. The parameter may be configured to limit a scope of view of the good by the at least one other user.

The good may be a publication having a plurality of pages. The portion of the good selected by the second user may be a page number of the plurality of pages. The parameter may be a number of continuous pages surrounding the page number that is less than all of the plurality of pages.

The aforementioned may also be achieved by providing a computer implemented method to generate a price for goods based on a personalized value set by a buyer of the good. The method may include the steps of (i) providing, via a content hosting computer system, a plurality of sellers, each seller associated with creation of at least one good assigned to one or more of a plurality of categories, each category associated with a plurality of buyers, (ii) allowing, via the content hosting computer system, the plurality of sellers to set one or more levels of access to respective goods of the sellers;, (iii) allowing, via the content hosting computer system, the plurality of sellers to set additional access parameters for sharing respective goods of the sellers, (iv) storing, via a memory associated with the content hosting computer system, the one or more levels of access as associated with (a) respective goods of the sellers, and (b) respective buyers of the respective goods of the sellers, (v) determining a value for each of the goods based on (a) information submitted by the buyers, and (b) interaction of the buyers with the goods, (vi) ranking the goods based the determined values for each of the goods, and/or (vii) presenting, via a viewer associated with the content hosting computer system, the rankings of the goods to the buyers.

The information may be submitted by the buyers includes a maximum potential payment for each of the plurality of categories of the goods. The interaction of the buyers with the goods may include gathering value scale ratings from the buyers after the buyers have gained one or more levels of access to respective goods of the sellers.

The personalized value for one of the goods may be determined via multiplying the maximum potential payment set by one of the buyers for a category of one of the goods by a predetermined percentage set by one of the sellers of the one of the goods. The personalized value for one of the goods may be determined via dividing the maximum potential payment set by one of the buyers for a category of one of the goods by a predetermined percentage set by one of the sellers of the one of the goods.

The aforementioned may also be achieved by providing a computer implemented method to set a price of a good in virtual marketplace. The method may include the steps of (i) providing, via a content hosting computer system, a plurality of options for buyers to interact with goods provided by sellers, the plurality of options for buyers to interact with the goods including (a) viewing the goods, (b) sharing the goods, and (c) purchasing the goods, (ii) assigning a value score to each of the goods based on information submitted by the buyers for respective ones of the goods, and/or (iii) processing each of the goods according to the value score of the respective goods.

The step of assigning the value may include (a) identifying a plurality of weighted factors for each of the goods, a highest of the weighted factors associated with an average payment amount by the buyers for the respective good, and/or (b) adjusting the value score based on the plurality of weighted factors. A second highest of the weighted factors may be associated with a number of shares by the buyers for the respective good. A third highest of the weighted factors may be associated with a number of views by the buyers for the respective good.

The method may further include the step of generating an initial estimate rank for each of the goods. The method may further include the step of updating the estimate of the rank for each goods based on weighted factors associated with the value score. The method may further include the step of ranking the goods according to the updated estimate of the rank. The method may further include the step of presenting the ranked goods to the buyer.

The aforementioned may also be achieved by providing a computer implemented method for discovering the high quality goods among a plurality of goods in a content market computer system on the Internet. The method may include the step of providing at the content hosting computer system a plurality of creator users, each seller creating at least one goods, each goods with a plurality of categories, each category containing a plurality of Supporter users. The method may include the step of providing a content hosting computer system that allows sellers to create, categorize, and determine buyer levels of initial, upfront, access to the goods. The method may include the step of providing a content hosting system that allows sellers to determine levels of additional access granted to viewer users for sharing the work via social networks, email or any internet sharing tool. The method may include the step of storing, at a particular entity, Access Level data in association with the goods that authorizes buyer upfront access to the goods. The method may include the step of storing, at a particular entity, Access Level data, in association with the goods that authorizes Supporters to gain additional access to the goods for performing various actions. The method may include the step of storing, at a particular entity, Highest Payment data, in association with each buyer that gauges a Supporter's highest payment value for each category of goods. The method may include the step of determining for each goods a Value based upon the highest payment data, individual payment selection, buyer value ratings, and buyer engagement. The method may include the step of storing, at a particular entity, Value data, in association with the goods that is used for ranking and discovery of highest quality goods. The method may include the step of ranking the goods based upon their respective values. The method may include the step of presenting the ranked information Goods with visual value data to a buyer.

The visual value data may include an average of all personal value ratings for individual goods by each individual buyer who viewed and rated the good in the Content Market Computer System. The visual value data may include the average payment selections for each buyer who accessed and paid the seller directly in the content market computer system. The visual value data may include the total number of buyers who access and paid the seller directly in the content market computer system. The visual value data may include the average shares carried out by each buyer who accessed and shared the goods in the content market computer system. The visual value data may include the total number of buyers who accessed and shared the goods in the content market computer system. The visual value data may include the average views carried out by each buyer accessed the goods in the content market computer system. The visual value data may include the total number of users who accessed and viewed the goods in the content market computer system.

The aforementioned may also be achieved by providing a computer system to control distribution and incentivizing of viral distribution of goods in a marketplace. The system may include a computer network configured to provide a digital content marketplace that allows a creator of a good to monetize the good by providing one of a plurality of access levels to the good to each of a plurality of consumers of the good. The system may include a controller configured to be utilized by the creator to set an initial access level of the plurality of access levels for each of the plurality of consumers. The system may include a viewer configured to allow each of the plurality of consumers to view the good at the initial access level associated with each of the plurality of consumers. The system may include a processor configured to rank the good based on each interaction with the good by one or more of the plurality of consumers. The system may include a memory configured to store the initial access level associated with each of the plurality of consumers and the good, and the ranking associated with the good.

### BRIEF DESCRIPTION OF THE DRAWINGS

FIG. 1 is a diagram illustrating a computer network utilized by the system of the present inventive concept to provide a virtual marketplace;

FIG. 2 is a diagram illustrating a plurality of modules associated with a content market module for use with the virtual marketplace illustrated in FIG. 1;

FIG. 3 is a flowchart illustrating a process provided by the system of the present inventive concept for a seller to create goods, set an access level for the goods, publish the goods, and sell the goods to buyers;

FIG. 4 is a flowchart illustrating a process provided by the system of the present inventive concept for a buyer to gain access to goods of a seller, determine a value of the goods, and choose between various actions to gain additional access to the goods;

FIG. 5 illustrates an exemplary view provided by the system of the present inventive concept to a buyer of a good;

FIG. 6 illustrates an exemplary view provided by the system of the present inventive concept to a buyer with an option to share goods to gain additional viewing time for the goods;

FIG. 7 illustrates a plurality of exemplary views provided by the system of the present inventive concept provided to a buyer of a good to generate a price base of value ranking or generate value ranking based off a selected price;

FIG. 8 illustrates an exemplary view provided by the system of the present inventive concept to a buyer of a plurality of goods ranked according to the system of the present inventive concept;

FIG. 9 illustrates an exemplary view provided by the system of the present inventive concept to a seller depicting a portion of a publishing process where the seller is able to categorize a good;

FIG. 10 illustrates an exemplary view provided by the system of the present inventive concept to a seller depicting a portion of a publishing process where the seller is able to determine levels of openness and levels of access that affect distribution of the good;

FIG. 11 illustrates an exemplary view provided by the system of the present inventive concept to a buyer depicting a library of goods whereby the seller has gained access to the good prior to sharing the good or paying for the good;

FIG. 12 illustrates an exemplary view provided by the system of the present inventive concept to a buyer depicting a library of goods whereby the seller has paid the seller for the good or sufficiently shared the good a number of times deemed necessary by seller to gain permanent access to the good;

FIG. 13 illustrates an exemplary view provided by the system of the present inventive concept to a buyer depicting a feature of the system of the present inventive concept configured to allow the buyer to make additional payments to a seller of a good as the buyer discovers the value of the good over time, and directly contact the seller of the good;

FIG. 14 illustrates an exemplary view provided by the system of the present inventive concept to a seller depicting a feature of the system of the present inventive concept configured to allow the seller to maintain direct contact with buyers who either pay for, share, or comment on a good of the seller; and

FIG. 15 illustrates a user interface screen of a text and/or multimedia editor that can be used to create and upload goods.

### DETAILED DESCRIPTION

Although the following detailed description contains specifics for the purpose of illustration, anyone familiar with systems used for the accessing, distributing, and ranking internet content understands that many methods and variations for the storing and distribution of goods could be used for the execution of the marketplace such as streaming, digital download, data stores, etc. The following embodiments are set forth without imposing limitation on the present inventive concept.

As previously discussed, goods may include images, e-books, audio recordings, video recordings, computer applications, and/or any other forms that can be transferred over a communication network like the Internet. Although all users in the social pay-what-you-want marketplace or virtual marketplace provided by the system of the present inventive concept will have an ability to both create, control levels of access, publish, market, sell and virally distribute goods as well as gain initial access, determine the personal value, pay for, share, and consume goods in the marketplace and on the Internet, such users are generally categorized as either sellers or buyers—to best describe the present inventive concept.

The term “seller” is interchangeable with term “creator”. A seller and/or creator may include an individual creator of the good, such as but not limited to, an artist, writer, musician, software engineer and many other like examples. A seller can also include larger entities that seek to sell a good although they did not the create the good, such as but not limited to, a publishing company, record label, movie studio, software company or any like entity that has the legitimate ownership or rights to sell a good, which may include entities that acquire the right to sell a good by contracting with the goods' creator. A seller may also include a collective entity that is the creator of the good, such as newspaper, magazine, media company among many others. Sellers may use the digital marketplace to draft, upload, control and determine levels of access and levels openness, publish, market, virally distribute and sell goods.

The term “buyer” is interchangeable with the term “supporter.” A buyer can mean any person or entity that seeks to gain access, own, or use a good. Buyers discover, consume, which can mean watch, view, listen, play, read, execute etc., discern the personal value of the goods, then either pay the sellers this perceived personal money value to gain permanent access to the goods with varying incentives if available, or share the work via social networks, email or other sharing tools to gain additional access.

Sellers set limits and thresholds that determine the way in which buyers interact with their goods both in marketplace and in other locations on the Internet such as search engines and personal websites and therefore determine the way in which the goods are distributed in the marketplace and on the Internet. Sellers set these limits and thresholds for each goods individually, and these limits and thresholds, as well as the goods themselves, can be changed and adjusted by the seller at any time after the publication of the goods. It is important to note that these limits and thresholds are not meant to emulate the scarcity of digital rights managed goods as seen in U.S. Patent Publication No. 2013/0060616A1 and U.S. Pat. No. 8,364,595, which are incorporated by reference in their entireties, but instead to create a new, open, distribution model for professional, paid goods on the Internet while still keeping the goods protected from users who do not share or pay for the goods. These limits and threshold then determine the levels of predetermined, initial, upfront access that potential buyers can use to determine the personal value of the goods before paying sellers directly or sharing the goods to gain additional access.

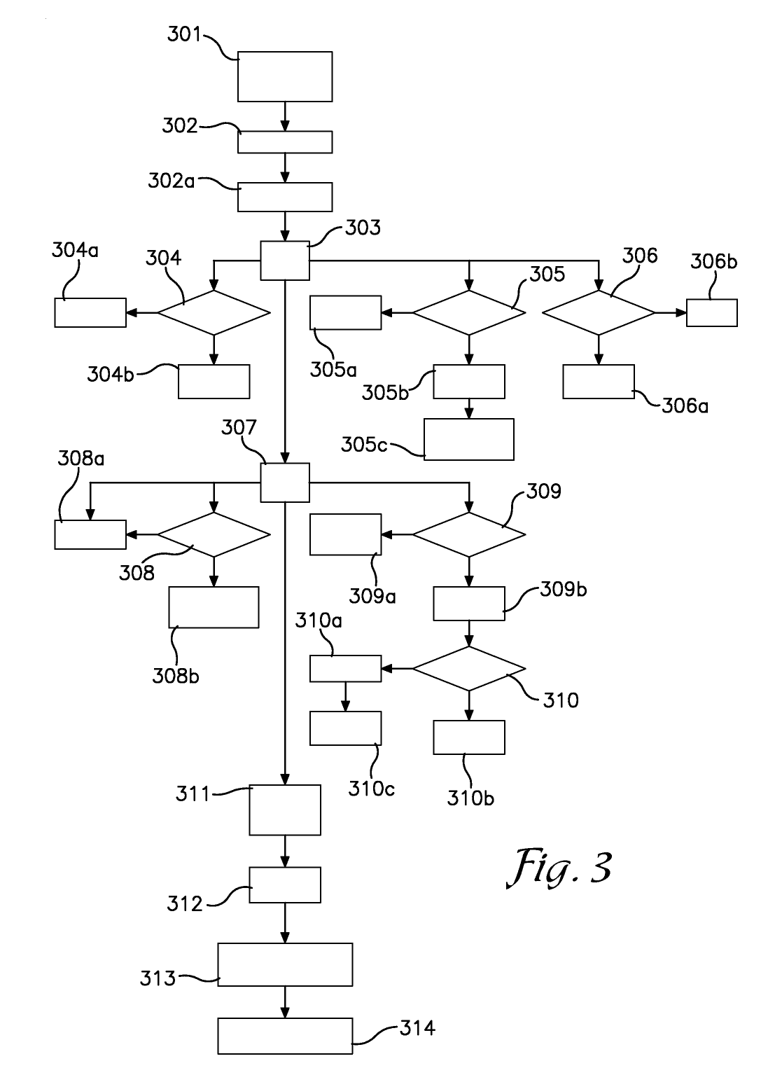

For the purpose herein, these limits and thresholds can be separated into two different categories—Levels of Openness and the Levels of Access. Levels of Openness as depicted in FIG. 3 determine the way in which new buyers, who have not signed in or registered, shared, or paid for the goods in the marketplace can discover and view the goods on the Internet for the first time. These levels of Openness can be described as limits and thresholds, such as but not limited to, how much of the work is discoverable or “crawlable” by search engines, how much of the work can be directly linked to in the Direct Linking System, how many pages a new buyer can view in the direct linking system before being asked to sign and start the Payment Period, and how many pages of the work are open to Internet Users to preview. In many cases, the Levels of Openness set by the seller will determine the good's ability to be discovered and accessed by new buyers on the Internet.

In additional to levels of opening or access levels, creators and/or sellers of goods also determine levels of access, as depicted in FIG. 3 step 307. These levels of access are granted to buyers for performing various actions. Although all levels of access are a part of a suggested publishing process that allows paid content to be viral distributed on the Internet while still being protected, Sellers ultimately have the ability to choose whether they want to activate and use varying levels of openness and access for distributing their goods.

This initial, predetermined, upfront access allows buyers to determine the personal value of the goods. However, the personal value of the goods may vary for each individual due to financial, social, or any other factors. For example, although child with little money pays significantly less than businessman for the goods, the child's payment may represent a higher personal value than the businessman's. For this reason, the marketplace deploys two methods to determine the personal value of the goods.

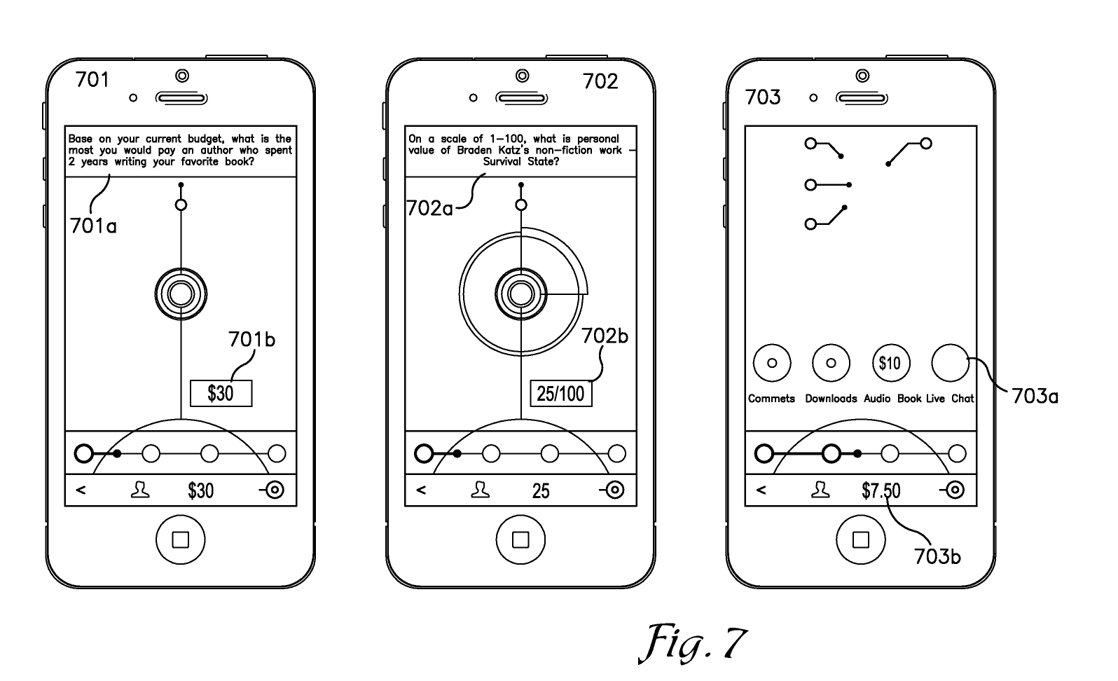

First, a method that generates a suggested payment price based off the buyers and/or supporters personal valuation of the goods called the Price Generator Method is depicted in the screenshots and user flow depicted in FIG. 7. Each buyer is asked a question that gauges the most they would pay a seller and/or creator for producing the highest quality work in a particular category. An example of such a question would be “Based on your current budget, what is the most you would pay an author who spent 2 years writing your favorite book?” The payment number that the buyer selects would then represent the highest possible personal money value rating for the goods for that individual user. After gaining access to at least one of the goods in the marketplace and consuming it (watch, read, execute, etc.), the buyer would then use a slider user interface depicted in FIG. 7 item 702b to select numerical value rating such as a value between 1 and 10 for the one of the goods in a particular category. This numerical value rating is then used as a percentage and represents the buyer's personal value rating of the goods in a particular category, which is likely determined by the levels of access granted to the buyer by the seller. This percentage value is then multiplied by the individual buyer's highest possible personal payment for the goods in the same broad category, and generates an individual price suggestion for the buyer. The buyer can then decide to change that price in the second and final user interface screen 703 in FIG. 7 in the payment flow in order to gain access to additional incentives—like digital downloads, audiobooks, live-chats or any other form of incentives selected by the individual Creator.

The Price Value Method simply eliminates the Price Value Generator, and asks buyers to determine a price based off of both their assessed personal value of the work with the incentives as shown in screen 703 in FIG. 7. The marketplace then determines a percentage value based on the individual buyer's highest payment amount for that particular category of goods.

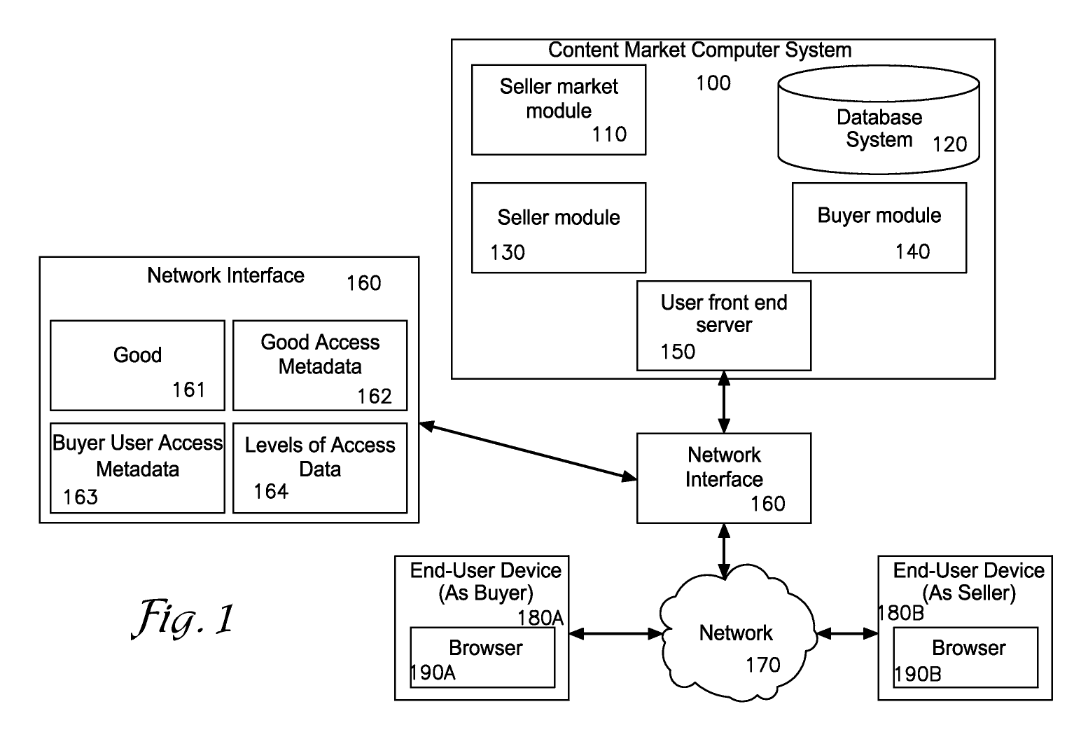

Turning to FIG. 1, a computer network is illustrated having a virtual marketplace or content market computer system 100. Through the browser 190b in the user computer 180b, the content market computer system 100 gives sellers the ability to create goods in creator module 130, determine levels of access and receive payments in the content market module 110, and publish the goods to be viewed by buyers through the browser 190a in the user computer 180a. The network 170, which can be the Internet, LAN, wireless network, or any form of communication network, connects each component.

While the network 170 is described as a user computer system, it is used to represent various wired and wireless devices such as computer desktops, laptops, and mobile devices such as smartphones, tablets and any other networked multimedia device. Although only a single seller computer is shown in 180b and buyer 180a, the system and publishing process depicted in FIG. 3 can be used by many thousands or millions of sellers creating many thousands or millions of goods; and each seller computer could be used as a buyer computer and vice-versa.

In the system database 120, which is connected to network 170, stores information that is connected to the content Market computer system 100 such as the goods that populate the marketplace, goods payment, sharing, comments, and other usage data that is incorporated into the Human Impact Ranking, as well as system-wide usage data.

The content market module 110 contained within the content market computer system 100 provides a system that receives new goods submissions from the seller through the creator module 130 within the front end server 150, ranks these submission with the Human Impact Ranking System, provides a means to make and receive payment from an external or internal online payment system, receives and tracks buyer metrics which are then stored in the system database 120. The content market 110 uses buyer metrics to provide these ranked and organized goods through the user front-end server 150.

Levels of access data 162 collected from the content market computer system 100 is stored in an association with each goods 161 and this Level of access data 164 is activated depending on buyer access metadata 163 that is collected in association with each buyer's actions and transferred via the network interface 160, which acts as an intermediary. Levels of access data 162 broadly represents data that, on a per-user basis, indicates the levels of access granted to individual buyers for an individual goods. These levels of access are dependent on the buyer actions that are represented in the buyer Access metadata 163, and the levels of access determined by sellers, which is represented in goods access metadata 162.

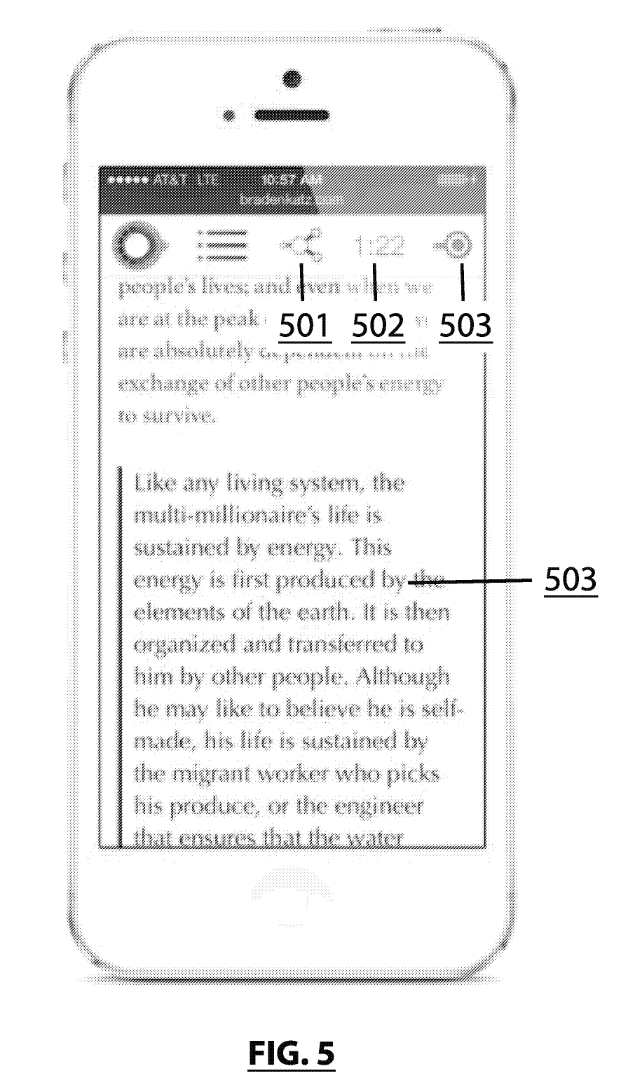

Information good access metadata 162 broadly represents levels of access and levels of openness specification data in association with goods 161 that is determined by sellers. Information good access metadata may represent the time limit in which new buyers gain predetermined, upfront access to the goods in an application depicted in FIG. 5, the additional access granted for sharing the work via social networks, email or other internet sharing tools, the portion of the work that is available to unregistered buyers on the Internet, among several other factors determined by sellers in the publishing process depicted in FIG. 3 steps 303 and 307.

Buyers' access meta data 163 broadly represents data that, on a per-user basis, indicates actions and behavior for each buyer in relation to each of the goods, such as but not limited to, the amount a buyers pays a seller, the number of times the buyer shares the goods, the number of times a buyer views the goods 161, and the number of times a buyer comments on the goods, among other factors.

For the purpose of describing these data models, a “module” could be implemented as a hardware, firmware, and/or software that is assigned and thereby performs a specified functionality. However, the modules as well as the content market computer system 100 represent just one of many different possible implementations and variations of the marketplace. Each module can potentially perform a different function, or a singular module could execute several functions.

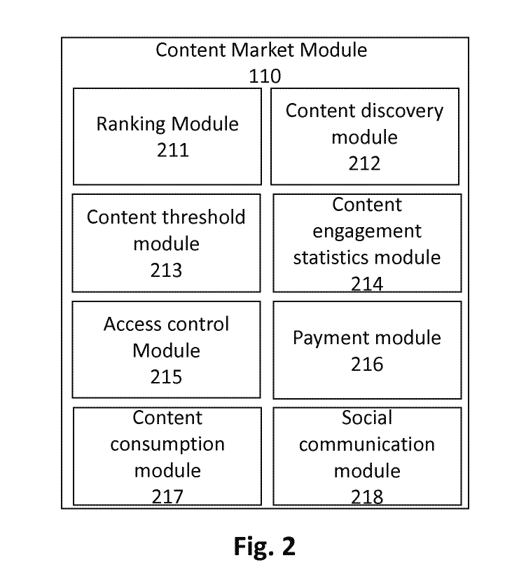

Turning to FIG. 2, the content market module 110 is illustrated. The content market module 110 connects sellers, who are seeking to acquire new buyers who will pay them directly and share their goods, with buyers, who are looking to discover, consume, which can mean read, watch, listen, execute, etc., discern the value, pay and share goods. Sellers determine levels of access and levels openness via the content threshold control module 213; and these levels of access and levels of openness are carried out and executed for individual goods in the access control module 215. The consumption, which can mean reading, watching, listening, executing etc. of Information goods in the web application depicted in FIG. 5 is carried out via the content consumption module 217.

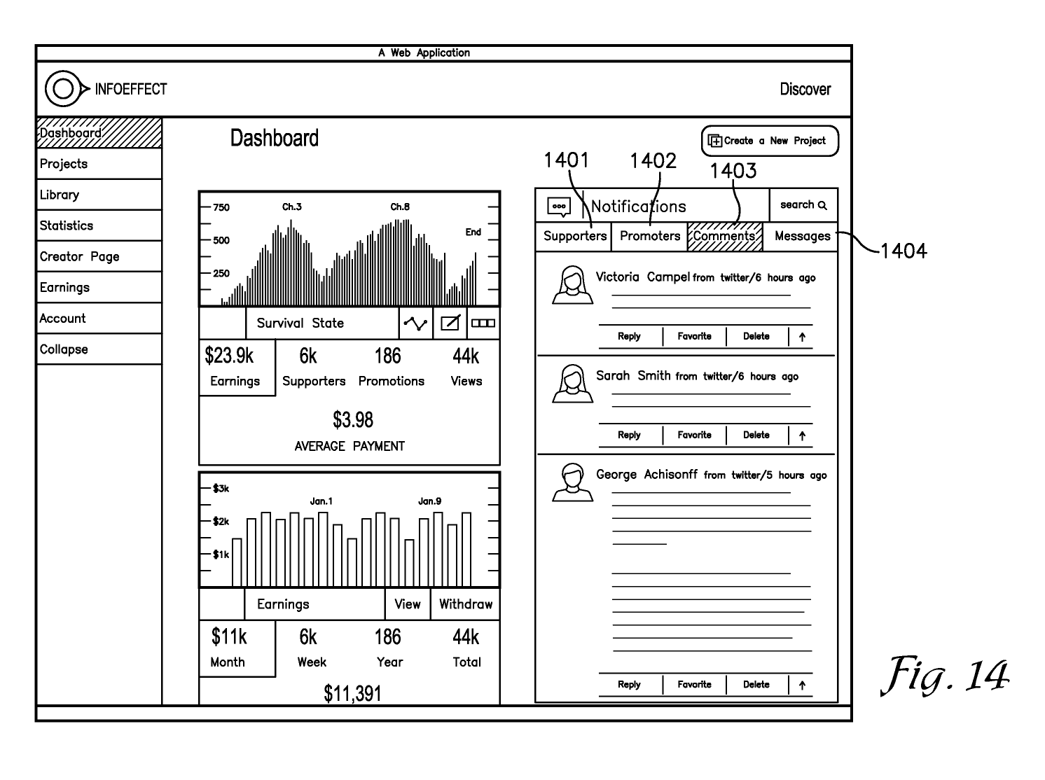

Although both the content engagement statistics module 214 and the ranking module 211 use similar data like the total number of shares, payments, views etc., the content engagement statistics module 214 is used solely for providing meaningful feedback to sellers via the dashboard interface depicted in FIG. 14. These statistics can range from the total number of payments for an goods, to more specific metrics such as the total number of shares for a specific portion of an goods.

The ranking module 211 deploys the Human Impact Ranking System to rank goods in order to identify the most valuable goods for buyers by collecting and processing value metric data from the Content Market Computer System 100. Value metric data includes, among other factors, the total amount earned by each good, the number of buyers who paid for each goods, the average payment for each goods, the total number of shares for each goods, the total number of buyers who shared each goods, the average number of shares by each buyer who accessed and shared the information Good, the total number of views, the total number of buyers who viewed the good, and the average number of views by each buyer. The Human Impact Ranking Module may collect value metric logs in real time and process a ranking for all goods in the Content Market Computer System 100, or it may do so in time intervals such as daily or weekly.

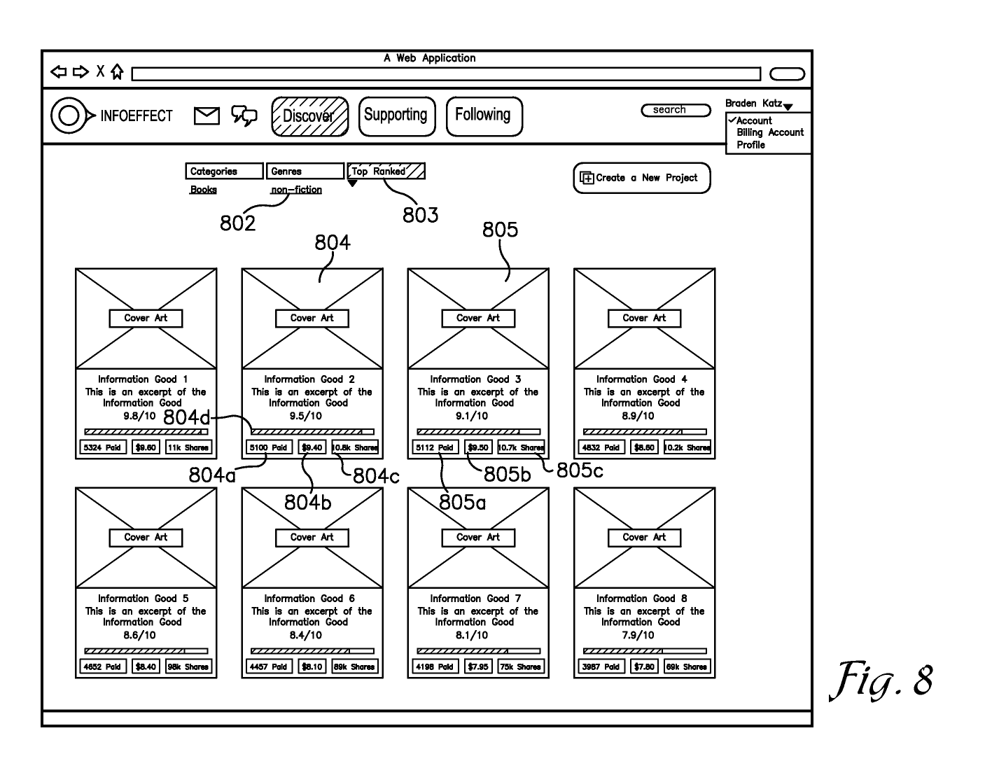

The content discovery module 212 has two different but related functions. First it allows the marketplace to store individualized statistics on each goods that used by buyers to identify the most valuable goods among a plurality of other goods as partially depicted in the marketplace Screen in FIG. 8. Second, it allows buyers to search for individual goods, and these searched goods can be sorted by their Human Impact ranking or other more specific metrics.

The payment module 216 is used to connect buyers with sellers through a payment medium that is either executed with an internal payment system such as a credit card processor or external online patent system such as Amazon Payments™, PayPal™, Stripe™ and/or Balanced Payments™ among others. Buyers can make payment and sellers can receive these payments through the payment module 216.

The social communication module 218 allows sellers and buyers to directly communicate in order to foster a more direct engagement. All users can communicate to each other via messaging. However, the social communication module 218 may be mainly used between sellers and buyers who are connected via a goods as depicted in FIG. 14.

Although the following specific examples are used to describe the present inventive concept, there are a multitude of methods that may be used to allow sellers to control the distribution of goods on a communication network such as the Internet. The following examples are not meant to limit the scope or methods of executing the present inventive concept.

In one embodiment, the goods 161, goods access metadata 162, buyer access metadata 163, and levels of access data 164, are stored at the Content Market Computer System 100. The goods may then be “distributed” by either granting or revoking buyers' access to the goods in a web application depicted in FIG. 5 by updating the Levels of Access Data 164 based off an individual buyer's actions, which are represented by the buyer access metadata 163, and the Levels of Access and Levels Openness determined by the seller, which are represented in the goods access metadata 162. This method, which stores the goods and all associated data on a Content Market Computer System 100, allows goods to be virally distributed across the Internet by simply granted and revoking access to the goods, instead of physically transferring the goods to digital storage at the buyer's device 180a.

In another embodiment, the Information good and all associated data and metadata can be distributed by initiating the transfer of the Information good to the digital storage of a buyer's device 180a, which can be a mobile phone, laptop computer, desktop computer among many others. In this instance, the goods 161, goods access metadata 162, buyer access metadata 163, and level of access data 164, are transferred to the digital storage of a buyer's device 180a from the content hosting computer system 100. Although the entire goods 161 may be stored on the buyer's device 180a, the level of access data stored on the buyers device may be updated based on the buyer's actions, which are represented in the buyer access metadata 163, and the levels of access and levels of openness parameters chosen by the seller in the publishing process depicted in FIG. 3, which are represented in the goods access metadata 162. Therefore, although the goods is stored in its entirety on the buyer device, the buyer's may or may not gain complete access to the goods depending on the levels of access and levels of openness chosen by sellers. These levels of access and levels of openness may determine the way in which the buyer interacts with the goods, as well determine the likelihood that the buyer shares the goods on the internet.

As described herein, a Human Impact Ranking for a social pay-what-you-want marketplace for professional goods. Although the following detailed description contains specifics for the purpose of illustration, anyone familiar with common ranking methods will understand that that many variations and alterations are within the scope of the present inventive concept. The following embodiments are set forth without imposing limitation on the ranking system.

The ranking of Internet content, such as the Pagerank system seen in U.S. Pat. No. 6,285,999, has traditionally been associated with calculating totals of common ranking metrics for each article of published content. These metrics include, but are not limited to, the number of views the content receives, the total number of shares the content receives (e.g. Tweets, Pins, Reddits, emails, Facebook Likes, etc.), the time spent by users on the content (e.g. bounce rate), the total number of social bookmarks the content receives (e.g. Reddit, Delicious, etc.) the total number of back-links the content receives, and the total number of comments the content receives among many others. While the ranking systems that utilize these metrics are important for determining the content's popularity and relevance among Internet users, they often fail to capture the content's true quality and impact in the marketplace.

The Human Impact Ranking (HIR) stands apart from all other ranking systems as it gauges the impact of an goods by 1) granting buyers predetermined, upfront access to the creative work before performing actions, or metrics, that signify value 2) assessing the value of the goods for each buyer by tracking individual personal value metrics 2) assigning different weights to metrics based off of these personal user valuations and 4) incorporates buyers payment selection's in the pay what you want marketplace as a the highest weighted factor because these payment selections theoretically represent buyer's personal valuation of the goods based on his or her predetermined, upfront access and subsequent consumption of the goods.

Unlike other systems, which assign weights to the individual metrics themselves and calculate a ranking by determining the total count for an individual article of content, the weight of each metric in the Human Impact Ranking can either increase or decrease based off the individual buyer's actions. For example, although goods A and goods B have identical personal value ratings, payment selections, total shares, and total views, goods A can have a higher ranking because, of the total sharing metrics, the majority of the users who shared the goods A shared it multiple times, while for goods B, the vast majority of the shares were carried out by users who shared the work one time.

Individual metrics like social shares that are carried out multiple times by the same user have a higher weight in the Human Impact Ranking, as they signify that the goods has a higher personal value or impact to the individual user who carried out the actions multiple times. This system also incentivizes sellers to grant buyers additional and/or permanent access to their goods for sharing the work via social networks, email or other sharing tools.

The Human Impact Ranking Algorithm (HIRA) assigns weights to metrics based off the number of times these metrics, or actions, where performed by individual buyer users, and computes the rank for a particular goods. The HIRA assigns the highest weight to the payment selection metric as it is deemed as the most valuable metric in determining the contents quality in the formal economy. The HIRA scheme that weighs in various factors mentioned above is proposed as follows:

CR(c)=n{[(W_{c}^{P}^{_{Indv}}*P_{Indv})+(W_{c}^{E}^{_{P}}*Σᵤ_{ᵢ}_{εu(c)}^{i=1:n}E_{P}_{ᵤᵢ})]+[(W_{c}^{Sh}^{_{Indv}}*Sh_{Indv})+(W_{c}^{E}^{_{Sh}}*Σᵤ_{ⱼ}_{εu(c)}^{J=1:o}E_{Sh}_{ᵤⱼ})]+[W_{c}^{V}^{_{Indv}}V_{Indv})+(W_{c}^{E}^{_{V}}*Σᵤ_{ₖ}_{εu(c)}^{k=1:p}Eᵥ_{ᵤₖ})]}

where CR(c) is content rank for content c and n is the normalizing or dampening factor.

For payments made by buyers to sellers, W_{c}^{P}^{_{Indv}} is the weight for each U.S.(United States) dollar paid to sellers by a buyers for goods C. P_{Indv} is the average number U.S. dollars paid by each buyer who accessed and paid for goods C. W_{c}^{E}^{_{P}} is the weight for every U.S. dollar that has been paid and uᵢ ε u(c) represents the number of buyers who have accessed and paid for goods C. The algorithm assigns more importance to higher U.S. dollar amounts paid by individual buyers as the value of W_{c}^{P}^{_{Indv}} is always assigned a higher weight over the value of W_{c}^{E}^{_{P}}. By default, payments hold the highest weight in the HIRA of the three other value metrics as they represent the buyer's personalized value of a goods in the formal economy. If the marketplace deploys the Price Generator Method, these payments may directly coincide with individual buyers' value scale rating of goods, and these value scale ratings and payments will theoretically be determined by the levels of upfront, predetermined access granted to buyers by sellers.

For shares of an goods by buyers via email, social networks or other sharing tool, W_{c}^{Sh}^{_{Indv}} is the weight for each individual share by users for goods C.Sh_{Indv} is the average number of shares by each buyer who accessed and shared the goods C. W_{c}^{E}^{_{Sh}} is the weight for every share that has been made for the goods C. uⱼ ε u(c) represents the number of users who have accessed and shared goods C. The algorithm assigns more importance to a higher number of shares made by individual users as the value of W_{c}^{Sh}^{_{Indv}} is always assigned a higher weight over the value of W_{c}^{E}^{_{Sh}}. By default, shares carried out by buyers have less weight than payments but a higher weight than views. Theoretically, it is logical that Shares are considered a more indicative of value than simply viewing the work but less indicative of value than paying Creators directly. However, depending on the number of shares carried out by an individual user and the payment amount, a share or set of shares may be assigned a higher weight than a payment.

For views of an goods by buyers, W_{c}^{V}^{_{Indv}} is the weight for each individual view for goods C. V_{Indv} is the average number of views by each buyer who accessed goods C. W_{c}^{E}^{_{V}} is the weight for every view of the goods C by a buyer. uₖ ε u(c) represents the number of users who have accessed and viewed goods C. The algorithm assigns more importance to a higher number of views made by individual users as the value of W_{c}^{V}^{_{Indv}} is always assigned a higher weight over the value of W_{c}^{E}^{_{V}}. By default, views have the lowest weight of the other three value metrics.

The summation of all the weights is always equal to one, and is consistent for particular classes of content. The normalizing factor ensures that the ranking of content does not balloon due to localized events. The values of each weight, as well as well value metrics themselves are subject to change during market testing.

Based on the performance of each seller's goods, a ranking scheme for sellers that depends on the success of each of their individual goods published using the metrics described in NPRA is formulated as follows:

AR(a)=nΣ_{c}_{ᵢ}_{ε1(c)}^{I=1:n}CR_{c}_{ᵢ}

where AR(a) is the ranking of seller a, a(c) is the set of all the goods published by a seller a, and CR(c) is the rank of goods c published by seller a. Also, n is again the normalizing factor. Using this formulation the authors for each genera can be assigned a rank, which is a reflection of the quality, value, and impact of their goods in the marketplace.

In practice, there are millions of potential goods and subsequent value metrics and weights to determine their quality, value, and impact in the marketplace. The following is a simplified, iterative, example for the purpose of illustrating the Human Impact Ranking Algorithm in an individual instance. However, many different variations are within the scope of the Human Impact Ranking, and many other value metrics may be applied to the Human Impact Ranking Algorithm above.

FIG. 3 describes the method of publishing and determining the levels of access and levels of openness of a goods by the sellers, which can mean individual artists, writer, musician etc., or any entity that seeks to publish a goods. The seller uses the computer system depicted in 170b and accesses the Content Market Computer System 100 via the personal end-user device 190b. The content market computer system 100 and the computers 170 are connected over a network 170 such as the Internet.

First, the Creator user drafts or uploads the work through Content Market Computer System 100 via the creator module 130 after successfully authenticating with the user front-end server 150. After the seller finishes uploading the goods via the Creator Module 130, it is stored in the content market computer system's 100 in the database 120.

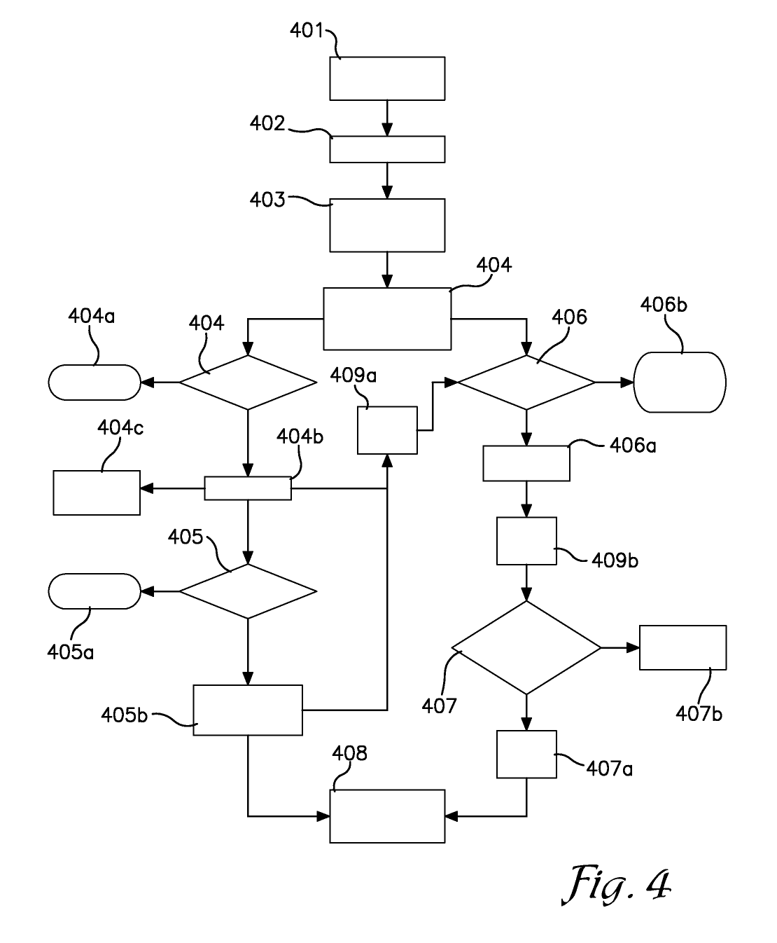

The levels of access chosen by sellers directly affect the way in which buyers interact with goods in the consumer module 140 through their computer 170a, browser 180a, and within the method depicted in FIG. 4. The buyers can explore the different goods within the content market computer system 100 through content discovery module 112 in the content market module 110.

In steps 301 and 302, a seller user registers for the marketplace with the intention of publishing and selling goods through the user front end server 150. The publishing process depicted in FIG. 3 will be performed for each goods individually, and sellers will be able to change the Levels of Openness, Levels of Access, and the goods itself, at any time. These levels can be configured within the Content Market Computer System 100 through the access control module 115 in the content market module 110. Although there are specific methods for determining Levels of Openness in FIG. 3 and in the detailed description, there are many different ways to restrict and determine Levels of Openness and Levels of Access to Internet content, and the examples set forth are not meant to limit the functionality of the marketplace.

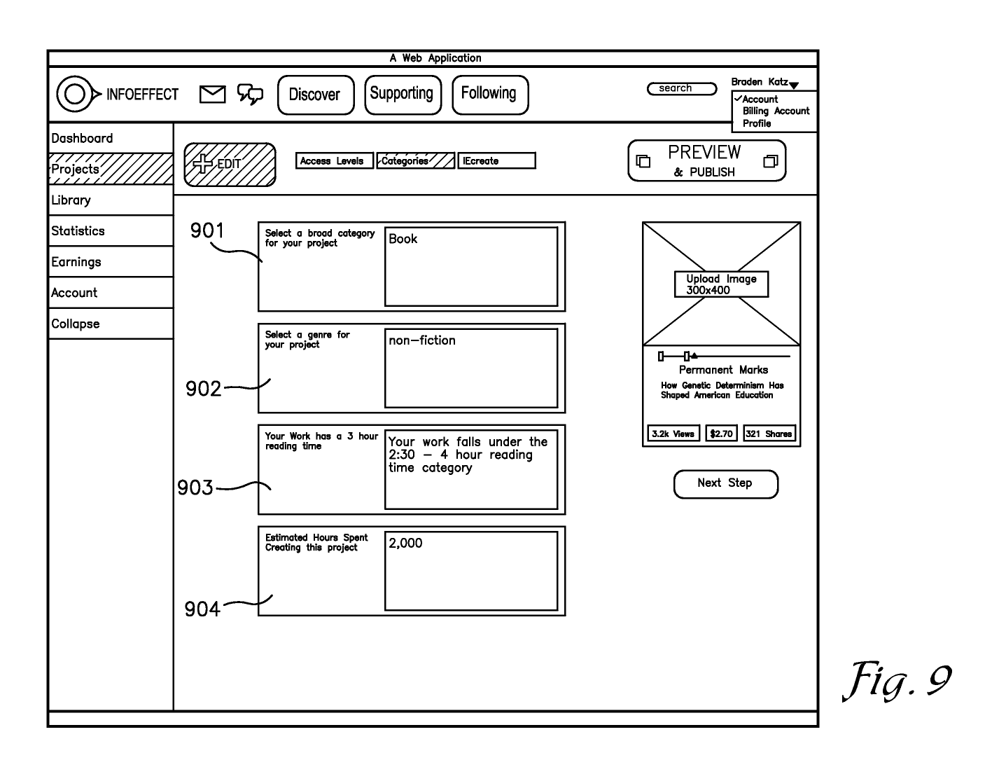

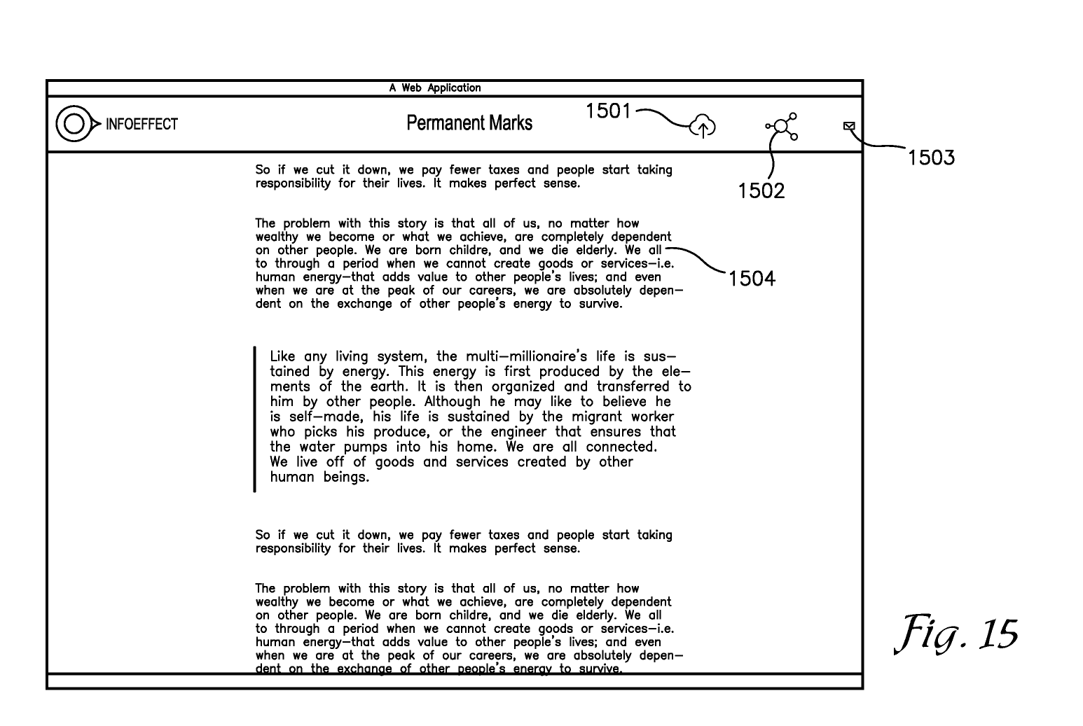

In step 302a, following the completion of the creation or upload of the goods in an User Interface such as the one depicted in FIG. 15, the seller determines broad categories such as “book” and its genre while the marketplace determines the length or consumption time of the goods as seen in the user interface depicted in FIG. 9. These categories are used both for sorting of goods as well as for generating suggested prices for buyers.

In steps 303,304,305, and 306, the seller determines levels of Openness for an individual goods. These levels openness determine how much of the work is available to Internet users who have not signed in to the marketplace, and it therefore determines how openly the work is discovered, accessed and shared on the Internet. In step 304, the seller decides whether the goods is discoverable by search engines, which is executed in the Content marketplace Module depicted in FIG. 2. If yes, the seller selects the portion of the work that he or she would like to be discoverable by search engines using the user interface in FIG. 1.

Next in step 305, the seller decides if a portion of the work is accessible in the Direct Linking System. The Direct Linking System is designed to give goods the ability to be discovered, accessed, and shared instantaneously like free web content, while still giving it the ability to be closed off and protected to users who do not support or share the work. Although the direct linking system could be used for other forms of media like music and film, it is best suited for long-form written and multimedia works. In Step 305a, the seller determines how much of the work is accessible in the direct linking system by selecting a group of pages (for example, pages 1-22). Next in step 305b, the seller selects how many pages a new and/or unregistered buyer can travel before being asked to sign into and/or register for the marketplace (for example a seller could choose to allow unregistered buyers to travel 3 pages forward and backward from the initial link page), which may occur within the content threshold module 113. New buyers can than share and directly link in to any of the pages within portion of the goods in the Direct Linking System selected by the seller, and travel the determined number of pages forward or backward from the first page they linked to initially.

One potential method of many others for executing the direct linking system within the html5 reading application is through Content Market Module 110 in the content threshold module 113 by generating a new URL and redirecting an unregistered buyers to a copy of the goods from the page that the unregistered buyer linked to initially. This copy of the goods also generates the number of pages both forward and backward from the initial link-in page. The unregistered buyer can then travel that number of pages both forward and backward, and is stopped and asked to register for the marketplace when they have traveled to the end of the copy of the goods. In an additional method, access to any section of the good in the Direct Linking System can be done via a URI schema containing the good identifier, an optional page number or paragraph number, and a text range to specify a given piece of text within the page or paragraph range in which unregistered buyers can travel. Once the direct link has been established, interaction with the good is constrained to the restrictions imposed by the access meta data 162.

Next in step 306, the seller decides if he or she would like there to be a preview section of the goods that is accessible to all Internet Users. If the seller chooses to not have a preview sectioning 306b, the work is not accessible to unregistered buyers who have not signed into the Marketplace or, in some instances; it is only accessible to unregistered buyers who have entered the work through the Direct linking system. If the seller chooses to have a preview section in step 306a, they select the number of pages for written or multimedia works, the amount of time for goods that can streamed like music and film, among other embodiments, that they would like to be included in the preview section.

Next in step 307, the seller determines levels of access for the individual goods. These levels of access are used by buyer to determine the personal value of the work in FIG. 4 step 404. Consequently, the sellers' predetermined levels of Access may or not affect the personal money value and subsequent payment by buyers as they are better able to make a Money Value Assessment with the highest Levels of upfront Access to the Information. First, in step 308, the seller decides if there is a Payment Period for buyers who first gain access to the goods. This Payment Period, which is expressed as a Time Period where unregistered buyers can gain complete, up front, access to the goods before they must either pay the Creator directly to gain permanent access to the goods with additional incentives if available, or share the goods once to gain more time in the payment period, acts as both a way to virally distribute and share the goods with new potential buyers, and as a means of creating a new more positive social interaction between sellers and buyers. If the seller chooses to not use the Payment Period in step 308a, buyers must determine the Personal Money Value of the goods upfront in the same way as a traditional pay wall. However, buyers are to able choose the price they are paying in exchange for permanent access to the goods. If the seller chooses to use the Payment Period in step 308a, the seller selects the amount of time granted to new buyers in the Payment Period. This Payment Period is then used by buyers to determine the personal money value of the goods in FIG. 4 step 404.

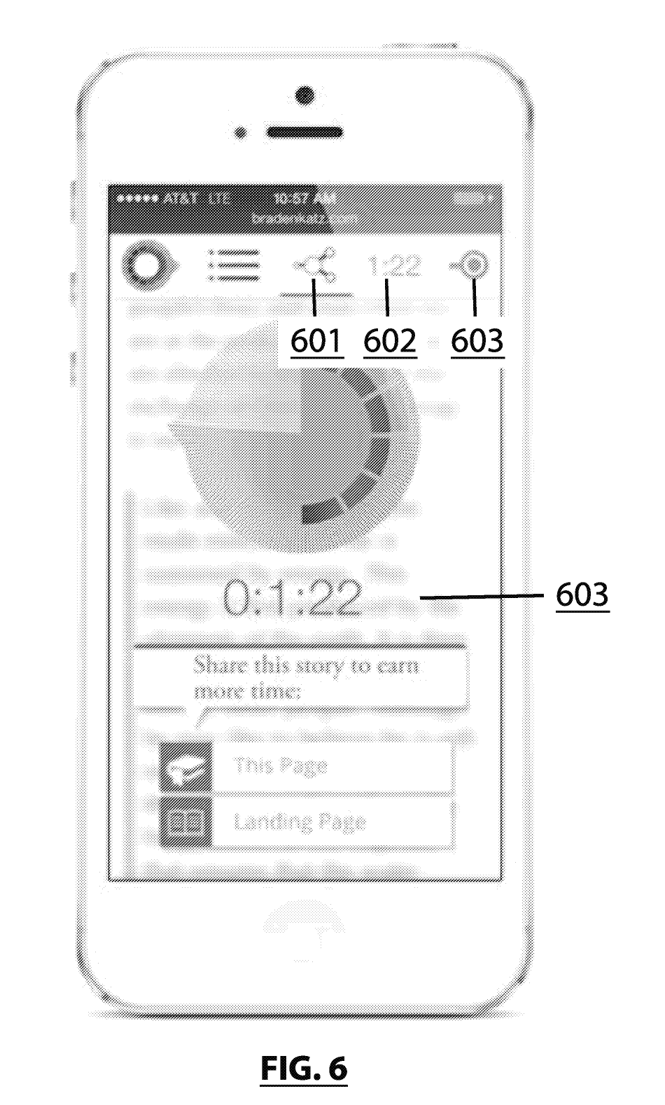

Next in step 309, the seller chooses if buyers of the goods can gain additional time in the Payment Period for sharing the goods via email, social networks, or other Internet sharing tools in the user interface depicted in FIG. 6 within the end-user device 180b. Levels of access and openness are carried out through the Content Threshold Module 113 in the Content Market Module 110 and stored in association with the goods as goods access metadata 162. If the seller chooses to not allow buyer to gain additional access by sharing the work, buyers can only gain additional access to the goods by paying the seller directly before, during or after the Payment Period expires in step 309a. If the seller chooses yes, he or she must first choose how much additional time in the Payment Period a buyer is granted for sharing the work one time in Step 309b. Next in step 309c, the seller selects the total number of times a buyer can gain additional time for sharing the work. For example, the seller may choose a restriction of five shares to gain additional time in the Payment Period. The seller can then decide if buyers are granted permanent access to the goods for sharing the work Multiple times in step 310. If no, buyers can only gain additional time in the Payment Period by either paying the creator directly for permanent access, or sharing the work a restricted or unrestricted number of times, depending on the Creators choice in step 309c, to gain additional access to the goods. If yes, the seller chooses the total number of shares a buyer must perform in order to gain permanent access to goods in the web application in step 310b. Finally in step 311, the seller selects the lowest payment thresholds for gaining various incentives such as but not limited, digital downloads, audiobooks, talks, live chats, higher quality audio etc., and publishes the goods in step 312. The content market computer system 100 formats the goods in the web application depicted in FIG. 5 in step 313.

Buyers in the marketplace use the Levels of Access and Levels of Openness determined by sellers in FIG. 3 to determine the personal money value of an individual goods. Theoretically, this personal money value assessment is determined by both the levels of access granted to buyers by sellers, as well as the quality of the individual goods as perceived by the individual buyer. Consequently, the payment selections made by buyers is assumed to be a more viable metric for the ranking and discovery of the highest quality goods on the Internet.

First in steps 401 and 402, a user signs up for the marketplace with the intention of becoming a buyer in the User Front End Server 150, and decides to view an individual goods in the HTML web application depicted in FIG. 5 via his or her browser end-user device in 180a. Depending on the Levels of Access and Levels of Openness, the buyer could enter the goods through a preview section or a section in the Direct Linking System through the Access Control Module 115. However, for the purpose of describing the buyer's process in the diagram in FIG. 4, he or she will begin on the landing page of the goods—which is a page used by sellers to market the work with quotes, descriptions etc.—in step 403.

Upon entering the work for the first time, the buyer is granted the Levels of Access selected by the Creator in FIG. 3 step 307. These levels of access directly affect the way buyers interact with the goods, and may or may not determine how the buyer determines the personal money value of the goods before either paying the seller directly or sharing the goods via email, social networks or any other internet sharing tool. It is also important the note the steps in the buyers process of determining the personal money value of the work may or may not happen linearly. Next in step 404, the buyer uses the initial Levels of Access and Levels of Openness to determine the money value of the work. This money value can be generated manually by the buyer or using the Price Generator shown in FIG. 7.

The Price Value Generator is a method for producing a price that represent the buyers' personal value rating of the work. In step 401, the buyer is asked a question that gauges the most they can affordably pay for the highest quality goods in a particular category. An example of this question could be “Based off of your current budget, what is the most you would pay to support an author who spent 2 years writing your favorite novel?” The buyer's answer is then stored and used as the highest possible personal money value rating for an goods in that category for that buyer individually. It is assumed that buyers' highest possible payment for a song would be different than a book, and the question above could be modified for any form of goods like books, music, film, software etc., and these values would be stored and used for to determine the highest possible payment for an individual user for goods by type and genre.

Once the highest possible money value payment is determined for a particular type of goods, the buyer may then be asked to rate an goods in association with step 404 after gaining initial Levels of Access determined by the seller in FIG. 3 step 307 with a percentage or rating slider user interface depicted in FIG. 7 user interface 702. The buyer's percentage rating is then multiplied by the highest possible money value rating for that particular genre or category for goods. For example, if a buyer's answer to question above is $20, and they rated an goods at 50%, then the suggested price to pay the seller would be $10. The buyer may land on a second User Interface Screen depicted in FIG. 7 interface 703 where they can choose increase or decrease the payment based off of the additional incentives selected by the seller.

The manual method simply eliminates the price value rating in FIG. 7 interface 702 and asks buyers to make payments based off their personal money value assessment in association with step 404 and the available incentives in FIG. 7 interface 703. However, assuming the marketplace has collected data about the highest possible payment for an individual user in a particular genre or category of goods, the buyer's payment could be used to generate a personal value rating after the payment is selected. For example, if a buyer's answer to the question “Based off of your current budget, what is the most you would pay to support an author who spent 2 years writing your favorite book?” is “$20,” and the buyer chooses to pay $15 for an goods in that genre or category, then the Value rating for that individual goods is 75 out of 100 or 75%. However, both the Price Value Generate and Manual Method require buyers to follow the method depicted in FIG. 4 that enables them gained predetermined upfront access to the goods.

After gaining initial Levels of Access and consuming (e.g. watching, reading, listening, executing etc.) the goods, the buyer decides if the work is valuable enough to share via email, social networks or other Internet sharing tools in step 404. If the goods is deemed not valuable enough to share, the buyer loses access to the goods in the web application after the Payment Period expires in step 404a. If yes, the buyer shares the work one time and gains the additional time selected by the seller in FIG. 3 step 309b, and the Buyers' Connection is established in 409a.

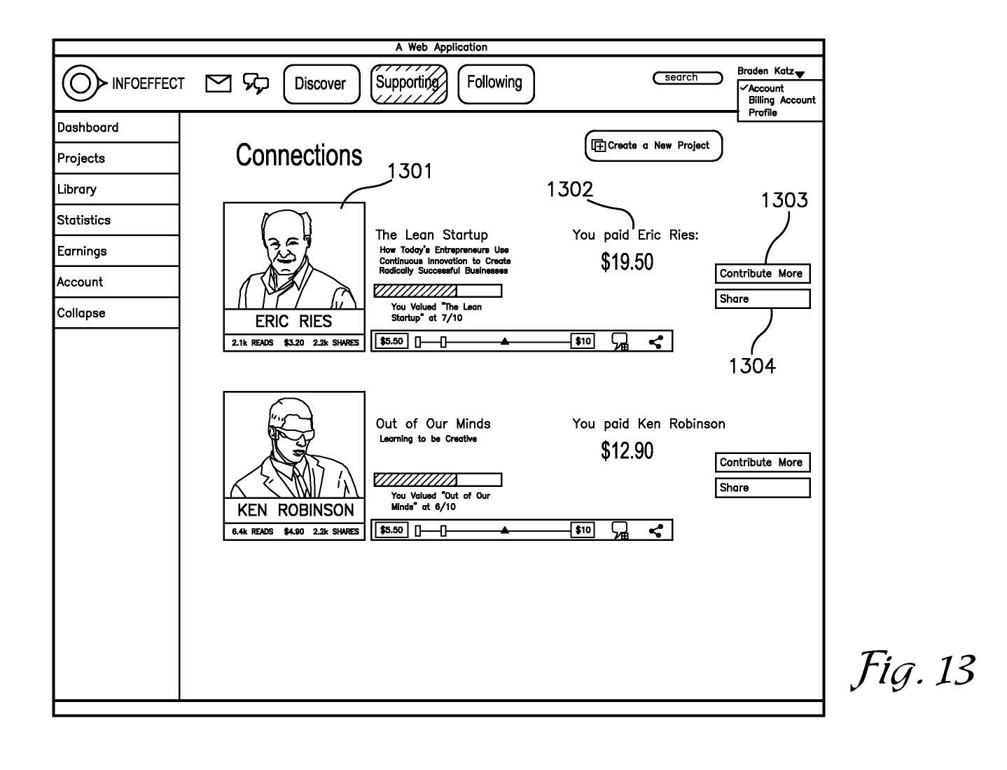

The Buyers' Connection, which is depicted both in FIG. 4 steps 409a and 409b, the User Interface depicted in FIG. 13, and within the social communication module 118, is a means of directly connecting sellers with buyers. The Buyers' Connection establishes a line of direct communication and also gives buyers the ability to make additional payments to sellers as they discover the true personal value of an individual goods over time. As mentioned earlier, buyers' ability to determine the true personal money value of an goods may not occur until weeks or even months after they initially gain access to the goods. For example, a user interface designer may gain access and read a book about User Interface Design, but does not put the ideas in the book into practice until several months after paying the seller directly and gaining access to the goods. After putting the ideas into practice, the web designer may discover that the ideas in the book save him a 30 minutes a day, which drastically increases the personal money value of the work. Consequently, the Buyers' Connection is established when a buyer pays or shares the work. From the seller's perspective, the Buyers' Connections gives them a direct line of communication to the people who are supporting their work, and may give them the ability to forge a meaningful connection as seen in the user interface depicted in FIG. 14.

Next in step 405, the buyer can determine if the work is valuable enough to be shared multiple times. If the buyer chooses not to share the goods, assuming that the buyer does not intend to pay the seller directly for permanent access to the goods, the buyer will lose access to the goods once the Payment Period and additional time for sharing the work once expires in step 405a. It is important to note that this decision may be influenced by the incentives the seller has put in place for sharing the work multiple times in step FIG. 3 step 310b. Buyers may be more likely to share the work multiple times if they know that it will result in permanent access to the goods. If the buyer chooses to share the work multiple times, the buyer can either gain permanent access to the goods for sharing it the number of times selected by the seller in step 310b, or they can share can gain additional time in the Payment Period for sharing the work the number of times below the restrictions set by the Creator in 310c.

Next in step 406, the buyer discerns if the work is valuable enough to pay the seller directly, and discerns the personal money value of the goods, which can be generated with either the Manual Method or the Price Value Generator mentioned above. If the buyer chooses not to pay the seller directly through the payment module 116 in the content market module 110 and does not share the work, they lose access to the goods in the web application after the Payment Period expires in step 406b. If the buyer chooses to pay the seller their corresponding personal money value, they gain permanent access to the work in the web reading application in step 406a. Upon choosing to pay the seller, the Buyers' Connection is established in Step 409b. Next in step 407, the buyer can choose to pay above the lowest payment threshold for various incentives, if selected by the seller in FIG. 3 step 311. If he or chooses to pay below the lowest payment threshold for various incentives, the buyer keeps access to the goods in the web application but does not gain additional incentives in step 407b. If the buyer chooses to pay above the lowest payment threshold for additional incentives, the buyer gains access to the additional incentives with the goods in step 407a. Finally, in step 408, buyers' sharing and payment data is stored and used to for the ranking and discovery of quality goods in the Natural Price Ranking algorithm in the marketplace.

To best describe the different ways in which the Levels of Access and Levels of Openness could be used to control and determine the way in which goods can be distributed by sellers and accessed by buyers across a global network like the Internet, we will give 3 different scenarios of sellers who place varying Levels of Openness and Levels of Access, and therefore varying levels of distribution, on an individual goods. First, Seller 1 is a well-known author who intends to sell her book to a large fan base directly. Second, Seller 2 is a musician releasing her first song who hopes to be discovered by new potential fans and buyers as well as make a profit. Third, Seller 3 is an activist and journalist who is writing long-form article to promote and raise money for a global initiative.

Because Seller 1's work is already in high demand, she has decided to eliminate the Payment Period in FIG. 3 step 308a, and only allow the first 2 chapters to be previewed by potential buyers in FIG. 3 step 306a. She creates incentives with varying payment threshold in FIG. 3 step 311, publishes her work to the marketplace, and she decides to give no additional access for sharing the work via internet social sharing tools in FIG. 3 step 309a. With the exception of the first 2 chapters, Seller 1 has essentially created a pay-what-you-want pay wall, and buyers must decide the marginal corresponding value of the book with limited access to the book. However, because the author is already in high demand, she believes that most buyers payments will not be affected, as they already believe she produces high quality goods. Although buyers have already made an upfront payment to gain permanent access to Seller 1's goods, they may also decide to pay her more if they discover more value after they have consumed the work with the Buyers' Connection.

Seller 2 is a new creator, and therefore wants to use both Levels of openness and Levels of access to help easily distribute her work across the Internet. She lets new potential buyers who have not signed in and/or registered, and therefore cannot pay her directly or share her work, preview 75% of her song on the open Internet in FIG. 3 step 306a. Once buyers have signed into the marketplace, she has given them enough time to listen to her song 3 times in the Payment Period in FIG. 3 step 308b, she has also chosen to give additional time in the Payment period for sharing the song once via social internet sharing tools in FIG. 3 step 309b, and she will give complete ownership of the song for buyers who share her song 10 times in FIG. 3 step 310b. She has also given incentives in FIG. 3 step 311, like behind the scenes videos of her making the song in a studio etc. Like all other forms of goods in the marketplace, buyers who pay her directly gain permanent access to the song in the web application in FIG. 4 step 406a. As a result of her choosing to more open levels openness—where 75% of her song can be listened to for free on the open Internet—as well as a high level of access—where she has allowed the sharing of song on social networks to act as form as currency—her song is shared with buyers that it would normally would not reach; and because buyers are given more access to her work to discern their marginal corresponding satisfaction with the work, she may or may not receive higher payments during the Payment period. Her work may also be ranked higher in with the Human Impact Ranking System because the majority of the buyers who shared Creator 2's goods did so multiple times in order to gain additional and in some cases permanent access.

Seller 3 has a different purpose than the other 2 sellers because his good is being used both as vehicle to raise awareness and funding for a cause. As a result, he has opened up 80% of the work to fully open on the web in FIG. 3 step 306a because he wants all Internet users who read the work to able to support the cause when they finish the journalism article. He has made the Payment period indefinite in FIG. 3 step 308b. By making the payment period indefinite, any buyer who gains access the goods after signing into the marketplace will have permanent and complete access to the goods until it is removed from the marketplace, and these buyers can promote or financially support the cause at any time both in the web viewing application and through the buyers connections. Consequently, Seller 3 has created an open journalism article in which people can contribute to his cause directly before, during or after reading it.

FIG. 5 depict a responsive web, mobile, or desktop application user interface that is used by buyers via the end-user device 180a. The screen shot depicted in FIG. 5 shows an goods (in this case a work of non-fiction), with predetermined levels of access granted to a buyer. Navigation button 501 allows buyers to gain additional access by sharing the work, which is depicted in FIG. 6. The countdown timer 502 displays the remaining time, or levels of access, that an individual buyer has in the Payment Period. Once the countdown timer expires, a pop up will appear asking the buyer to either pay the Creator Directly to gain permanent access to the goods with additional incentives if selected by the Creator during step 311 in the publishing process depicted in FIG. 3, or share the work to gain additional access selected by the seller in steps 309 and 310 in the publishing process depicted in FIG. 3. Navigation button 503 allows buyers to pay for the goods in the User Interface screen 703 in FIG. 7.

FIG. 6 depicts the sharing screen user interface of the same responsive web, mobile, and/or desktop application depicted, which is executed when a buyer who is consuming content in FIG. 5 presses the navigation button 501. As seen in the small countdown timer 602 and the large countdown timer 603, the focus of the sharing screen user interface is to incentivize buyers who haven't paid the seller of the goods directly to share the goods in order to gain additional access, which may be in the form of additional time in the Payment Period. However, the amount of time gained, as well as the number of shares that must be carried out by buyers to gain permanent access to the work are determined by the seller in step 310 and 311 of the seller's Publishing Process in FIG. 3.

FIG. 7 shows 3 different User Interface Screens that can be applied to two different methods—the Price Generator Method and the Price Value Method—for determining a personalized value for each buyer for each information Good in a specific category of goods. First, the User Interface Screen 701 depicts the first screen in the Price Generator Method. This screen would appear once for each broad category of goods, and buyer's answers would be stored in association with their registered account for a specific genre or category of goods in the Content Market Computer System. In User Interface Screen 701 item 701a, an Individual buyer is being asked “Based on the on current budget, what is the most you would pay an author who spent 2 years writing your favorite book?” The buyer's answer of $30.00 would then be stored as the buyer's personal highest payment data in association with all long-form books and used to generate a suggested price.

Next in the Price Generator Method in Screen 702, the buyer's asked to choose a numerical value rating, such as 1-10 or 1-100, that rates the goods based off their personal assessment of its value. This value rating, which in the example shown in User Interface Screen 702 is 25/100 or 2.5/10, is then used to generate a percentage rating and multiplied by the buyer's Highest Payment Selection for the category of goods. For the instance depicted in FIG. 7, the percentage rating of 25% is generated form the Buyers' Value Rating in 702b and multiplied by the buyer's highest payment selection of $30 in 701b. A price suggestion is then generated in user interface screen 703 for that specific genre or category of goods. In this instance, a $7.50 price is generated in 703b because it represents 25% of the buyer's highest payment selection on of $30.00 selected in 701b. The buyer can then decide to pay this amount directly to the seller in User Interface Screen 703. They may also increase or decrease this amount based off the incentives, as selected by the Creator in FIG. 3 step 312. The example depicted in FIG. 7 shows just one individual buyer action or instance of potentially thousands or millions of other instances in the Content Market Computer System 100, and the goods, as well as the highest payment selection in screen 701, the Value Scale Rating in screen 702, and payment screen in 703 can be applied to any number of goods in a plurality of categories, types, and genres for any number of buyers.

FIG. 8 depicts a User Interface Screen for the marketplace on a desktop that is either running though the browser 190a in the buyer computer 180a, or within a desktop, mobile, or tablet application that is connected to a communication network such as the Internet. Visual data that is tracked in content discovery module 212 within the content market module 110 in the content market computer system 100, is processed and displayed as visual data depicted in FIG. 8 content Item 804 and 805. In 804a and 805a, the total number of payments is displayed on goods 804 and 805. This payment total is used in comparison to the average payment made by each buyer who accessed and paid for the goods that is depicted in 804b and 805b. In 804c and 805c, the total number of shares is shown for each individual goods. Other data may be used to display the goods that is not shown in FIG. 8 such as the average number of shares for each buyer who accessed and shared the work, the total number of views for each buyer who accessed the work, and the average number of times each buyer who viewed the work.

These value metrics are used by the Human Impact Ranking to determine a value score and ranking for each goods via the human impact ranking module 211 in the content market module 110. This ranking can be determined for any plurality of Information goods as seen in the category selection 802.

FIG. 9 depicts a User Interface Screen that coincided with step 302a in the seller publishing process in depicted FIG. 3, as well as the Price Generator Method and Price Value Methods depicted in FIG. 7 screen 701 and 702. FIG. 9 is used by the content market hosting system 100 to collect data from sellers in order to organize individual goods. In form 901, the seller selects a broad category such as but not limited to, songs, books, software, films etc. In form 902, the seller selects a genre for their goods, such as but not limited to, non-fiction, fiction, and journalism for written works, documentary, and drama for films, or electronic and hip hop for music. Next, in form 903 the marketplace categories the goods based on length metrics such as the time that it takes to consume (watch, listen, read, execute etc.) the goods. These length metrics are then used to place goods in more specific categories based off of how long it takes to consume the goods, which may or may not affect how buyers value the goods.

Next in form 904, the seller can choose to give data that represents the estimated effort expended to create the goods such as the number of hour spent researching and creating, which can mean writing, playing, filming etc. the goods. In some instances, this data may be collected automatically in the Content Creation Module in the Creator Module 130 by monitoring or tracking the time logs of a seller in the html editor depicted in FIG. 15.

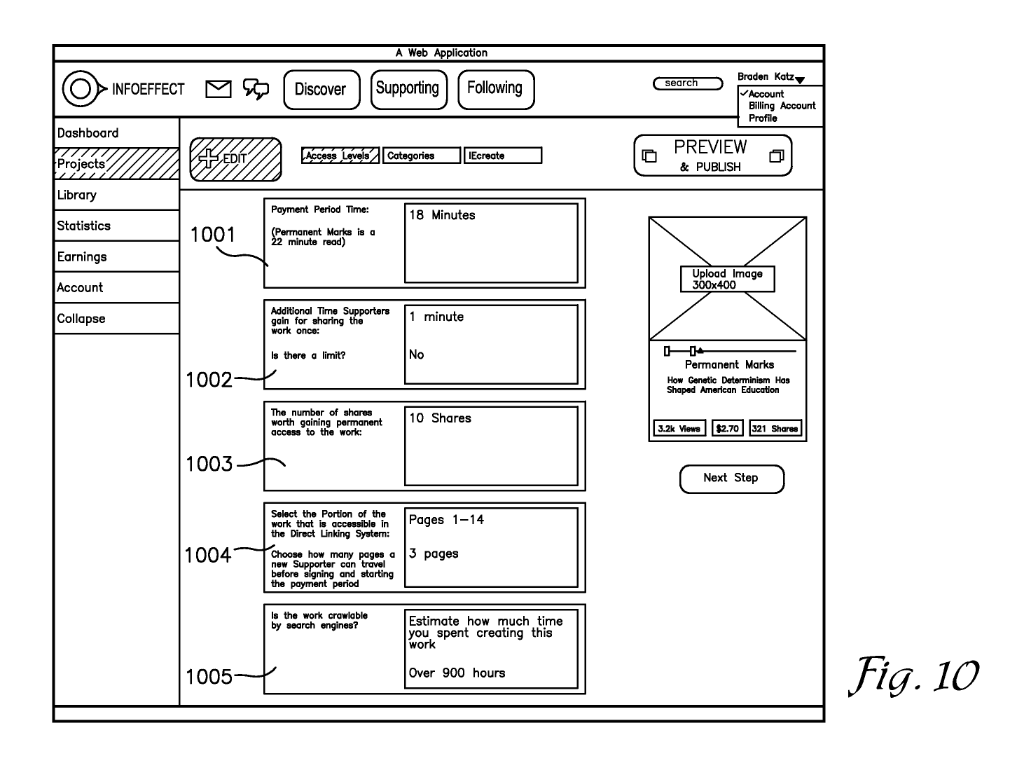

In the user interface screen depicted FIG. 10, the seller determines levels of access and levels of openness which are depicted in step 303 of FIG. 3 and executed via the content threshold module 213, and carried out by the access control module 215. In form 1001, the seller selects the Payment Period time limit, which is depicted in the countdown timer 502 in FIG. 5, that grants buyers predetermined, upfront access to the Information good before either paying the seller directly or sharing the work. Next in form 1002, the seller can select the amount of additional time gained to buyers for sharing the work once, as well as the limit of the number of shares that buyers can share the work to gain additional time. In the instance depicted in 1001, the sellers has granted consumer 1 minute of additional viewing time in the Payment Period and chosen to impose a limit on the number of times buyers can share the work to gain more time in the Payment Period. Next in form 1003, the seller can select the number of shares that buyers must carry out before gaining permanent access to the goods.

In form 1004, the seller can select the a portion of the work that is accessible through the direct linking system, which allows unregistered buyers to link directly to a position within the selected portion of the goods before signing as a buyer. The following question in from 1004 allows sellers to determine how many pages an unregistered user can travel from the original linking page in the direct linking system. When combined with the Payment Period, this system gives protected goods the capability to be directly discovered, accessed, and shared just like free content on the Internet. Next in form 1005, the seller can choose levels of openness of the goods, such as but not limited to, choosing if the goods, or a portion of the goods, is discoverable by search engines, and/or is formatted as an open preview section that can be viewed by unregistered buyers on the Internet.

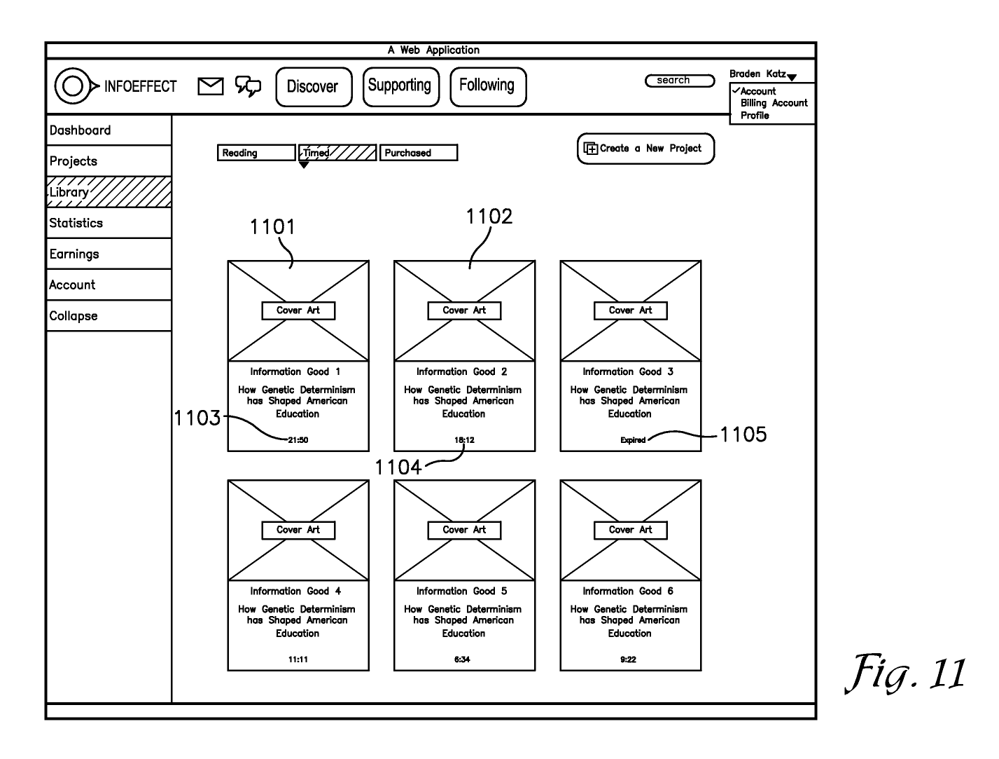

Upon choosing to consume an individual goods, that Individual goods appears in the buyer's library user interface screen depicted in FIG. 11. In this instance, the buyer is currently consuming six goods, each with varying levels of time remaining in the Payment Period depicted in countdown clock 1103 and 1104. This clock would be matched within the web application countdown timer 502 in FIG. 5, and only begins to countdown when the buyer is actively viewing the goods within the consumption web application in depicted FIG. 5. In goods 1105, the Payment Period has expired and, depending on the levels of openness and the levels of access selected by the seller for this particular goods, the buyer will be asked to either pay the seller directly to gain permanent access to the goods or share the goods to gain additional access time in the Payment Period when they attempt to view the work after the Payment Period has expired.

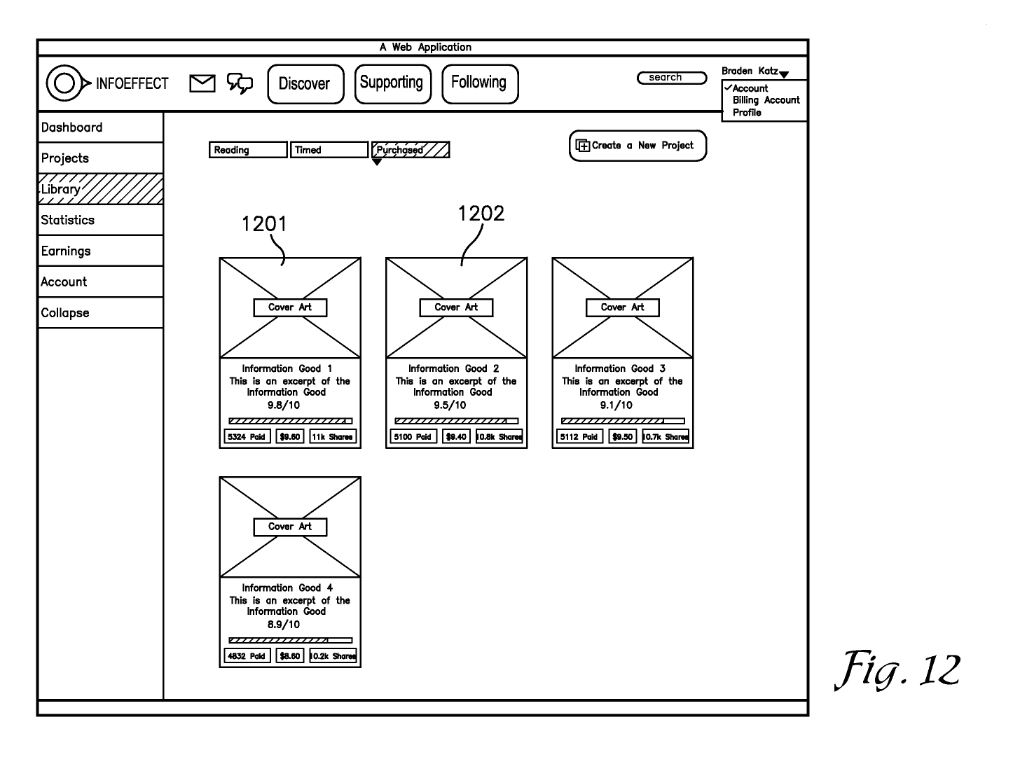

FIG. 12 depicts an individual buyer's goods that he or she “owns,” which in this instance means that he or she has either directly paid the Creator of the goods or shared the goods above the threshold selected by the good's seller in step 310b in the publishing process depicted in FIG. 3. Goods that have been purchased can be ranked and sorted using the Human Impact Ranking in the library user interface, and they use the same visual value data that is used for discovering quality goods in the marketplace as depicted in 1201 and 1202.

Upon viewing, sharing, or directly paying a seller for a goods, buyers establish a line of communication in the Buyer's and/or Supporter's Connection user interface depicted in FIG. 14 that is established via the social communication module 218 in the content market module 110. The Buyer's Connection can be used both as a direct means of communication between seller's and their buyers, and as a way for buyers to make additional contributions to sellers 1301 as they discover the value of an goods overtime using the “contribute more” button 1303, or they may choose to share the Information good using the share button 1304. In addition to making additional shares and contributions, buyers can also send messages or engage in direct chats with buyers using the navigation bar 1305.

For sellers, messages, payments, and all other activity in association with their personal goods are tracked in the “notifications” tile within their Seller Dashboard depicted in FIG. 14, and the Buyer's Connection acts as a means of directly communicating with the buyers who fund and/or pay for their goods. In the buyers tab 1401, sellers can track payments made to individual goods, as well as buyers personalized messages thanking them for their Support. In the promoters tab 1402, sellers can track the sharing activity of each goods and directly communicate with the buyers who share, or promote their work. In tabs 1403 and 1404, sellers can track and respond to comments and messages from buyers.

Content creation can mean drafting—which can mean writing, composing, editing etc.—or uploading goods to the Content Market Computer System 100. The editor user interface depicts just one type of content creation for one type of goods. In practice there is a plurality of other potential types of content creation for a plurality of other types of goods. In FIG. 15, seller's draft and edit written and multimedia works in the multimedia text editor depicted in 1504. Sellers may also upload source files, word documents, or other formats of a goods using navigation button 1501. Sellers may also choose to invite collaborators, such as editors co-authors etc. using the navigation button 1502, and publish or save a draft of the good using navigation button 1503.

Information and signals may be represented using any of a variety of different technologies and techniques. For example, data, instructions, commands, information, signals, bits, symbols, and/or chips referenced herein may be represented by voltages, currents, electromagnetic waves, magnetic fields or particles, optical fields or particles, and/or any combination thereof. Such information and signals may further undergo reformatting such as by device drivers and similar software tools to enable successful communication between components of the system.

Various illustrative logical blocks, modules, circuits, and/or algorithm steps described in connection with the embodiments disclosed herein may be implemented as electronic hardware, computer software, and/or combinations of both. To clearly indicate the interchangeability of hardware and software, various illustrative components, blocks, modules, circuits, and steps have been described above generally in terms of their functionality. Whether such functionality is implemented as hardware or software depends upon the particular application and design constraints imposed on the overall system. The functionality of the present inventive concept may be implemented in various ways for each particular application without deviating from the scope of the present inventive concept.

The various illustrative logical blocks, modules, and circuits of the present inventive concept may be implemented or performed with a general purpose processor, a digital signal processor (DSP), an application specific integrated circuit (ASIC), a field programmable gate array (FPGA) or other programmable logic device, discrete gate or transistor logic, discrete hardware components, and/or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, and/or any other such configuration.

The steps of a method or algorithm described in connection with the embodiments of the present inventive concept disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of embodiments of the presently disclosed inventive concept is provided to enable any person skilled in the art to make or use the present inventive concept. Various modifications will be readily apparent to those skilled in the art, and the generic principles defined herein may be applied alternatively without departing from the spirit or scope of the present inventive concept. Thus, the present inventive concept is not intended to be limited to the description herein but is to be accorded the widest scope consistent with the principles and novel features disclosed herein.

Though the embodiments described herein refer to a computer communicatively coupled to a hub module that is communicatively coupled to one or more external systems, it is envisioned that the computer, analysis module, and/or stored data may reside remotely from the sensor and display without departing from the spirit of the present inventive concept. In such cases, the sensor information and results may be exchanged between the sensor and display on the one hand, and the remote computer, analysis module, stored data and hub module on the other, via a communication network. In an embodiment of the present inventive concept then, the computer, analysis module, stored data and hub module may reside remotely on one or more devices such as in a cloud hosting system without departing from the spirit of the present inventive concept.

Method steps performed by the system of the present inventive concept as described herein may be interchanged without deviating from the scope of the present inventive concept.

Having now described the features, discoveries and principles of embodiments of the present inventive aspect of this disclosure, the manner in which embodiments of the present inventive aspect are constructed and used, the characteristics of such construction, and advantageous, new and useful results obtained; the new and useful structures, devices, elements, arrangements, parts and combinations, are set forth in the appended claims.

It is also to be understood that the following claims are intended to cover all of the generic and specific features of the present inventive aspect herein described, and all statements of the scope of the present inventive aspect which, as a matter of language, might be said to fall there between.

What is claimed is:

1. A computerized method to distribute goods, the method compromising the steps of:
providing access, via a computer network, to a virtual marketplace having a plurality of goods, each of the plurality goods associated with a first user and a second user;
allowing, via a processor of the network, one of the first users associated with one of the plurality of goods to assign one of a plurality of access levels to each of the second users for the one of the plurality of goods, the plurality of access levels including an initial access level, each of the plurality of access levels controlling a different level of interaction with the second users and the good;
storing, via a memory of the network, the plurality of access levels as associated with each of the second users;
assigning, via the processor, a value to each of the plurality goods, each of the values based on interaction of the second users with each of the goods;
organizing, via the processor, the goods based on the values to provide a ranking; and
presenting, via the processor, the goods to the second users based on the ranking.

2. The method of claim 1, wherein each of the plurality of access levels controls a viewing time that each of the second users are able to view a respective one of the goods associated with the access level.

3. The method of claim 2, wherein the viewing time is extended a predetermined amount of time each time the second user shares the respective one of the goods with at least one other user.

4. The method of claim 3, wherein the viewing time is infinite if the second user shares the respective one of the goods with a predetermined number of other users.

5. The method of claim 2, wherein the viewing time is determined based on (i) a number of shares performed by the buyer, and (ii) a number of shares required to gain permanent access to the good determined by the seller.

6. The method of claim 2, wherein the sharing of the good by the second user includes (i) sending a portion of the good selected by the second user to at least one other user, and (ii) applying a parameter predetermined by the buyer to the portion of the good, the parameter configured to limit a scope of view of the good by the at least one other user.

7. The method of claim 6,
wherein,
the good is a publication having a plurality of pages,
the portion of the good selected by the second user is a page number of the plurality of pages, and
the parameter is a number of continuous pages surrounding the page number that is less than all of the plurality of pages.

8. A computer implemented method to generate a price for goods based on a personalized value set by a buyer of the goods, the method compromising the steps of:
providing, via a content hosting computer system, a plurality of sellers, each seller associated with creation of at least one good assigned to one or more of a plurality of categories, each category associated with a plurality of buyers;
allowing, via the content hosting computer system, the plurality of sellers to set one or more levels of access to respective goods of the sellers;
allowing, via the content hosting computer system, the plurality of sellers to set additional access parameters for sharing respective goods of the sellers;
storing, via a memory associated with the content hosting computer system, the one or more levels of access as associated with (i) respective goods of the sellers, and (ii) respective buyers of the respective goods of the sellers;
determining a value for each of the goods based on (i) information submitted by the buyers, and (ii) interaction of the buyers with the goods;
ranking the goods based the determined values for each of the goods; and
presenting, via a viewer associated with the content hosting computer system, the rankings of the goods to the buyers.

9. The method of claim 8, wherein the information submitted by the buyers includes a maximum potential payment for each of the plurality of categories of the goods.

10. The method of claim 9, wherein the interaction of the buyers with the goods includes gathering value scale ratings from the buyers after the buyers have gained one or more levels of access to respective goods of the sellers.

11. The method of claim 10, wherein the personalized value for one of the goods is determined via multiplying the maximum potential payment set by one of the buyers for a category of one of the goods by a predetermined percentage set by one of the sellers of the one of the goods.

12. The method of claim 10, wherein the personalized value for one of the goods is determined via dividing the maximum potential payment set by one of the buyers for a category of one of the goods by a predetermined percentage set by one of the sellers of the one of the goods.

13. A computer implemented method to set a price of a good in virtual marketplace, the method compromising the steps of:
providing, via a content hosting computer system, a plurality of options for buyers to interact with goods provided by sellers, the plurality of options for buyers to interact with the goods including (i) viewing the goods, (ii) sharing the goods, and (iii) purchasing the goods;
assigning a value score to each of the goods based on information submitted by the buyers for respective ones of the goods; and
processing each of the goods according to the value score of the respective goods.

14. The method of claim 13, wherein assigning the value includes (i) identifying a plurality of weighted factors for each of the goods, a highest of the weighted factors associated with an average payment amount by the buyers for the respective good, and (ii) adjusting the value score based on the plurality of weighted factors.

15. The method of claim 14, wherein a second highest of the weighted factors is associated with a number of shares by the buyers for the respective good.

16. The method of claim 15, wherein a third highest of the weighted factors is associated with a number of views by the buyers for the respective good.

17. The method of claim 12, further comprising the steps of:
generating an initial estimate rank for each of the goods;
updating the estimate of the rank for each goods based on weighted factors associated with the value score;
ranking the goods according to the updated estimate of the rank; and
presenting the ranked goods to the buyer.

18. A computer system to control distribution and incentivizing of viral distribution of goods in a marketplace, the system compromising:
a computer network configured to provide a digital content marketplace that allows a creator of a good to monetize the good by providing one of a plurality of access levels to the good to each of a plurality of consumers of the good;
a controller configured to be utilized by the creator to set an initial access level of the plurality of access levels for each of the plurality of consumers;
a viewer configured to allow each of the plurality of consumers to view the good at the initial access level associated with each of the plurality of consumers;
a processor configured to rank the good based on each interaction with the good by one or more of the plurality of consumers; and
a memory configured to store the initial access level associated with each of the plurality of consumers and the good, and the ranking associated with the good.
